(19) United States
(12) Patent Application Publication
(10) Pub. No.: US 2026/0267272 A1
(43) Pub. Date: Sep. 10, 2026

(54) MEDIUM PROCESSING APPARATUS, IMAGE FORMING SYSTEM, AND NON-TRANSITORY RECORDING MEDIUM

(71) Applicant: Naohiro YOSHIDA, Kanagawa (JP)

(72) Inventor: Naohiro YOSHIDA, Kanagawa (JP)

(73) Assignee: ETRIA CO., LTD., Yokohama-shi (JP)

(21) Appl. No.: 19/556,372

(22) Filed: Mar. 4, 2026

(30) Foreign Application Priority Data
Mar. 6, 2025 (JP) 2025-035766

(51) Int. Cl. G03G 15/00

(52) U.S. Cl. CPC G03G 15/6538; G03G 15/6576; G03G 2215/00556

(57) ABSTRACT

A medium processing apparatus includes a medium stacker on which a medium is stacked and processing circuitry to predict a stacking limit on the medium stacker, based on attribute information of the medium and information about a process to be applied to the medium, and predict whether the medium stacker reaches the stacking limit when the medium is conveyed to the medium stacker before the process is applied.

### CROSS-REFERENCE TO RELATED APPLICATION

This patent application is based on and claims priority pursuant to 35 U.S.C. §119(a) to Japanese Patent Application No. 2025-035766, filed on Mar. 6, 2025, in the Japan Patent Office, the entire disclosure of which is hereby incorporated by reference herein.

### BACKGROUND

### Technical Field

The present disclosure relates to a medium processing apparatus, an image forming system, and a non-transitory recording medium.

### Background Art

Various types of medium processing apparatuses have been proposed that have a function to stack conveyed sheet media. In such medium processing apparatuses, not only cut-sheet media are stacked but also a medium bundle in which a plurality of media are bundled and bound can be stacked. Typically, a stacking unit is provided with a sensor that senses a full-load state.

### SUMMARY

The present disclosure described herein provides a medium processing apparatus, an image forming system, and a non-transitory recording medium. The medium processing apparatus includes a medium stacker on which a medium is stacked and processing circuitry to predict a stacking limit on the medium stacker, based on attribute information of the medium and information about a process to be applied to the medium, and predict whether the medium stacker reaches the stacking limit when the medium is conveyed to the medium stacker before the process is applied. The image forming system includes the medium processing apparatus and an image forming apparatus to form an image on the medium. The non-transitory recording medium stores a plurality of instructions which, when executed by one or more processors, causes the one or more processors to perform a method, and the method includes predicting a stacking limit on a medium stacker based on attribute information of the medium and information about a process to be applied to the medium. The predicting includes predicting whether the medium stacker reaches the stacking limit when the medium is conveyed to the medium stacker before the process is applied.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a diagram illustrating a schematic configuration of an image forming system.

FIG. 2 is a diagram illustrating a functional configuration of an image forming system.

FIG. 3 is a diagram illustrating a folding apparatus that is an example of a medium processing apparatus.

FIG. 4A and FIG. 4B are diagrams illustrating a fold-enhancing roller provided for the folding apparatus of FIG. 3.

FIG. 5 is a diagram illustrating a fold-enhancing mechanism provided for the folding apparatus of FIG. 3.

FIG. 6A, FIG. 6B, FIG. 6C, FIG. 6D, and FIG. 6E are diagrams illustrating fold-enhancing a fold-enhancing operation executed by the folding apparatus of FIG. 3.

FIG. 7A and FIG. 7B (FIG. 7) are diagrams illustrating the control blocks of an image forming system.

FIG. 8A, FIG. 8B, FIG. 8C, and FIG. 8D are diagrams illustrating training data used for the generation of a learning model, which is applicable to the control blocks of FIG. 7A and FIG. 7B (FIG. 7).

FIG. 9 is a flowchart of a control program.

FIG. 10A and FIG. 10B are diagrams illustrating sheets that are irregularly stacked on an output tray of the image forming system of FIG. 1.

FIG. 11 is a diagram illustrating a decurler apparatus provided for the image forming system of FIG. 1.

FIG. 12A and FIG. 12B are diagrams illustrating an internal structure of the decurler apparatus of FIG. 11.

FIG. 13A and FIG. 13B are diagrams illustrating sheets that are irregularly stacked on the output tray of FIG. 10A or FIG. 10B, which could be caused by varying ejection speed.

FIG. 14 is another flowchart of the control program of FIG. 9.

FIG. 15 is a diagram illustrating a user selection interface applicable to the medium processing apparatus of FIG. 3.

FIG. 16 is another diagram illustrating a user selection interface applicable to the medium processing apparatus of FIG. 3.

FIG. 17A, FIG. 17B, FIG. 17C, FIG. 17D, FIG. 17E, and FIG. 17F are diagrams illustrating a position-changing operation of an output tray provided for the medium processing apparatus of FIG. 3.

FIG. 18 is a diagram illustrating a position-changing mechanism of an output tray provided for the medium processing apparatus of FIG. 3.

FIG. 19 is still another diagram illustrating a user selection interface applicable to the medium processing apparatus of FIG. 3.

FIG. 20 is still another diagram illustrating a user selection interface applicable to the medium processing apparatus of FIG. 3.

FIG. 21 is a diagram illustrating a schematic configuration of an image forming system.

FIG. 22A and FIG. 22B are diagrams illustrating how the order in which jobs are executed is changed based on the control program of FIG. 9.

FIG. 23A and FIG. 23B are other diagrams illustrating a position-changing operation of an output tray provided for the medium processing apparatus of FIG. 3.

FIG. 24A, FIG. 24B, and FIG. 24C are other diagrams illustrating a position-changing mechanism of an output tray provided for the medium processing apparatus of FIG. 3.

FIG. 25 is still another flowchart of the control program of FIG. 9.

FIG. 26 is detailed flowchart of the control program of FIG. 26.

FIG. 27 is another detailed flowchart of the control program of FIG. 26.

FIG. 28 is still another diagram illustrating a user selection interface applicable to the medium processing apparatus of FIG. 3.

FIG. 29A and FIG. 29B are diagrams illustrating how a sheet-to-sheet time interval is changed, which is applicable to the medium processing apparatus of FIG. 3.

FIG. 30 is another diagram illustrating a schematic configuration of an image forming system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

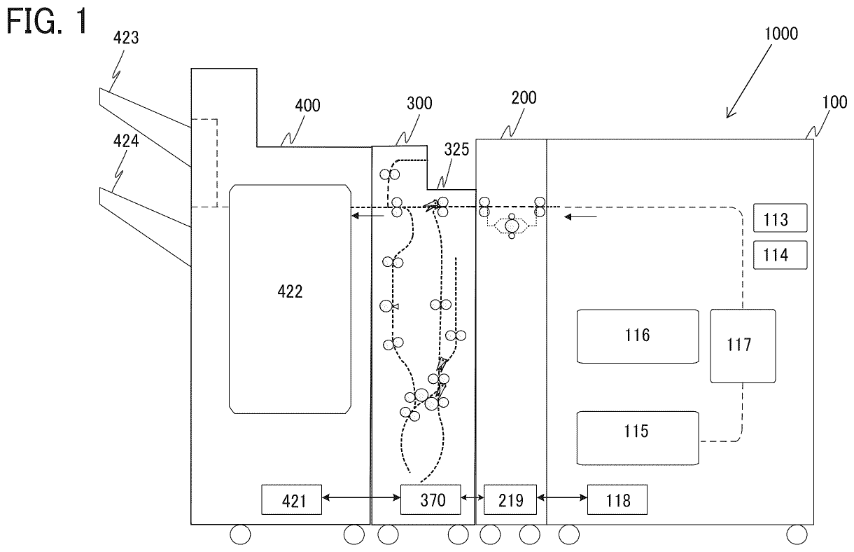

FIG. 1 is a diagram illustrating a configuration of an image forming system 1000.

As illustrated in FIG. 1, the image forming system 1000 includes an image forming apparatus 100, a decurler apparatus 200, a folding apparatus 300, and a post-processing apparatus 400. These apparatuses of the image forming system 1000 communicate with each other to share the information about operations to implement a cooperative operation.

The decurler apparatus 200, the folding apparatus 300, and the post-processing apparatus 400 are an example of a medium processing apparatus.

The image forming apparatus 100 is, for example, an apparatus that forms an image on the sheet P, which is an example of a sheet medium, by an electrophotographic process. The image forming apparatus 100 is provided with, at least, a display unit 113, an operation panel 114, a sheet feeder 115, an image forming unit 116, a fixing device 117, and an image formation controller 118.

The display unit 113 implements a function to notify a user of the detail of the operation and the status of apparatuses such as the decurler apparatus 200, the folding apparatus 300, and the post-processing apparatus 400. The operation panel 114 implements a function for a user to perform a setting operation of, for example, the mode change and the number of sheets. The sheet feeder 115 implements a function to store the sheets P and feed the sheets P separately on a one-sheet-by-one-sheet basis. The image forming unit 116 implements a function to form a latent image on a photoconductor and transfer the image onto the sheet P. The fixing device 117 implements a function to fix the image transferred onto the sheet P. The image formation controller 118 controls the operation of each element such that each element can implement a desired function. The image forming method for the image forming apparatus 100 is not limited to an electrophotographic method, and may be ink-jet printing in which liquid such as ink is discharged to the sheet P to form an image.

The folding apparatus 300 has a folding process controller 370 that controls the folding operation for the sheet P conveyed from the image forming apparatus 100 with a folding type or folding method designated by the image formation controller 118 of the image forming apparatus 100 through a communication. The folding process controller 370 controls a folding roller when a folding operation is performed, or communicates with a couple of controllers coupled to an upstream portion or a downstream portion.

In a similar manner, the decurler apparatus 200 and the post-processing apparatus 400 include a decurler control unit 219 and a post-processing control unit 421, respectively, that communicate with the folding process controller 370 and a couple of controllers coupled to an upstream portion or a downstream portion. The post-processing apparatus 400 also includes a post-processor 422. The sheet P that is conveyed from the image forming apparatus 100 is eventually ejected to one of a first post-processing output tray 423, a second post-processing output tray 424, and a folding-device output tray 325.

### First Embodiment of Learning Model Generation

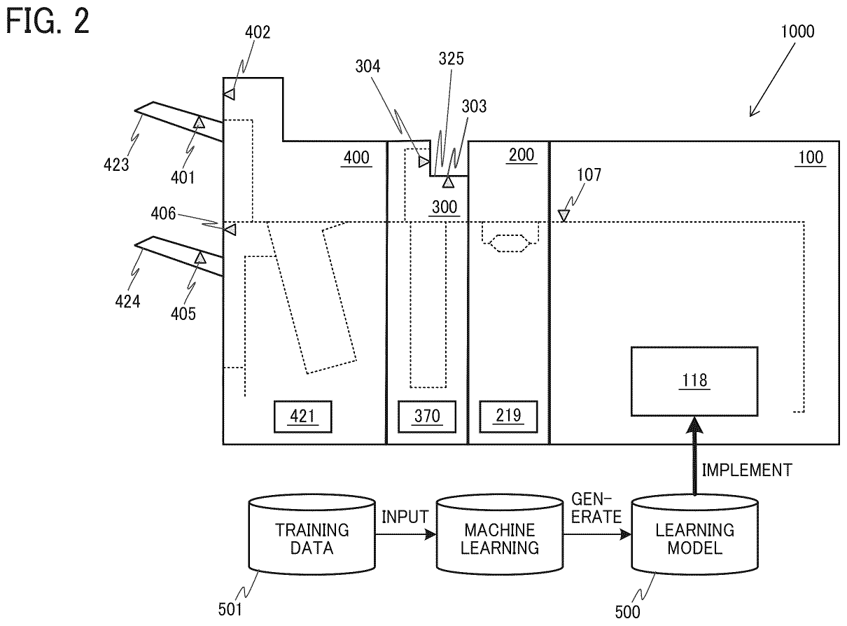

FIG. 2 is a schematic diagram of the image forming system 1000 illustrating how a learning model 500 is generated through machine learning processes and a sensor used for ejection-controlling processes making use of the learning model 500.

The learning model 500 generated through the machine learning processes is implemented by a control program that is executable by the image formation controller 118 provided for the image forming apparatus 100. The learning model 500 is generated by analyzing training data 501 obtained based on the evaluation at design time, making use of so-called cloud services or external information processing devices that can generate learning models. The learning model 500 that is generated is a kind of computational algorithm, and is implemented as a module as a part of a control program. How the learning model 500 that is implemented is used will be described later in detail.

The learning model 500 may be provided for the control circuits such as the decurler control unit 219, the folding process controller 370, and the post-processing control unit 421 provided for the processing units other than the image forming apparatus 100, including the decurler apparatus 200, the folding apparatus 300, and the post-processing apparatus 400. In such cases, the timing of a stacking limit is predicted for an output tray based on the data about the image formation or the data about the post-processing operation sent from the image forming apparatus 100. Such a prediction includes a full-load prediction step, and that output tray includes the first post-processing output tray 423, the second post-processing output tray 424, and the folding-device output tray 325, each of which is an example of a medium stacker and is provided for one of the apparatuses located downstream from the image forming apparatus 100. The process of full-load timing prediction at each output tray will be described later in detail.

As illustrated in FIG. 2, the image forming system 1000 is provided with a medium sensor 401 that senses whether a sheet bundle Pb or the sheets P are stacked on the first post-processing output tray 423. Moreover, a full-load sensor 402 that is an example of a full-load detection device to sense whether the first post-processing output tray 423 is fully loaded is provided. In a similar manner, the image forming system 1000 is provided with a medium sensor 405 that senses whether a sheet bundle Pb or the sheets P are stacked on the second post-processing output tray 424. Moreover, a full-load sensor 406 that is an example of a load-amount detection device to sense whether the second post-processing output tray 424 is fully loaded is provided.

The image forming system 1000 is provided with a medium sensor 303 that determines whether the sheet bundle Pb or the sheets P are stacked on the folding-device output tray 325. Further, the image forming system 1000 is provided with a full-load sensor 304 that determines whether the folding-device output tray 325 is fully loaded.

The image forming system 1000 is provided with a curl sensor 107 that determines whether the conveyed sheet P is curled before the sheet P is ejected to the decurler apparatus 200.

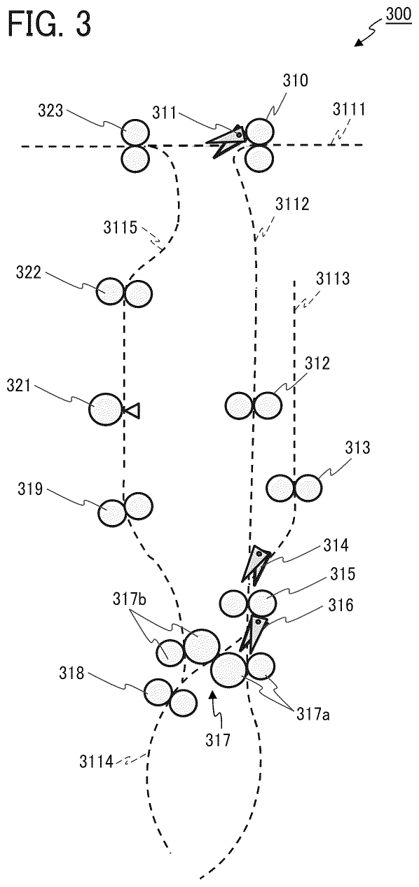

FIG. 3 is a sectional view of the conveyance path of the folding apparatus 300.

The sheet P, which is sent from the image forming apparatus 100 and is received through a first conveyance path 3111, is conveyed to a downstream portion of the image forming system 1000 by a first conveyance roller 310. When a folding operation is to be performed on the sheet P, the position of the first branching member 311 is switched such that the sheet P branches to the second conveyance path 3112, and the first conveyance roller 310 is driven to convey the sheet P. Accordingly, the sheet P is conveyed from the first conveyance path 3111 toward the second conveyance path 3112.

By contrast, when a folding operation is not to be performed on the sheet P, the position of the first branching member 311 is not switched, and the sheet P is directly conveyed by the conveyance operation of the first conveyance roller 310 and the seventh conveyance roller 323 along the first conveyance path 3111 to the post-processing apparatus 400 connected to a downstream portion of the image forming system 1000.

The sheet P is folded as a fourth conveyance roller 318 and a folding roller 317 including a first folding roller 317a and a second folding roller 317b rotate both forward and reverse directions. The sheet P that is folded by the folding roller 317 is switched back and its conveyance direction is reversed as the fourth conveyance roller 318 rotates both forward and reverse directions in the fourth conveyance path 3114 illustrated in FIG. 3. Then, the sheet P is conveyed upward along a fifth conveyance path 3115 by the conveyance operation of the second folding roller 317b and a fifth conveyance roller 319, and a fold-enhancing operation is performed at a fold-enhancing roller 321. Then, the sheet P that has gone through a fold-enhancing operation is conveyed further upward by the conveyance operation of a sixth conveyance roller 322, and merges with the first conveyance path 3111. Moreover, the sheet P is conveyed by the conveyance operation of the seventh conveyance roller 323 along the first conveyance path 3111 to the post-processing apparatus 400 connected to a downstream portion of the image forming system 1000.

When a plurality of sheets P are to be folded, those sheets P are aligned and overlaid in a third conveyance path 3113 before the folding operation on the sheets P by the folding roller 317.

In other words, the sheet P that has been conveyed to a downstream portion by the second conveyance roller 312 is directly conveyed to a further downstream portion of the image forming system 1000 by the third conveyance roller 315 and the first folding roller 317a through the second conveyance path 3112. When the rear end of the sheet P in the conveyance direction passes through a second branching member 314, the second branching member 314 is switched such that the sheet P is guided to the third conveyance path 3113. Subsequently, the third conveyance roller 315, the first folding roller 317a, and an eighth conveyance roller 313 are rotated in the reverse direction to convey the sheet P to the third conveyance path 3113. Due to such configurations as described above, a plurality of sheets P can be aligned and overlaid in the third conveyance path 3113.

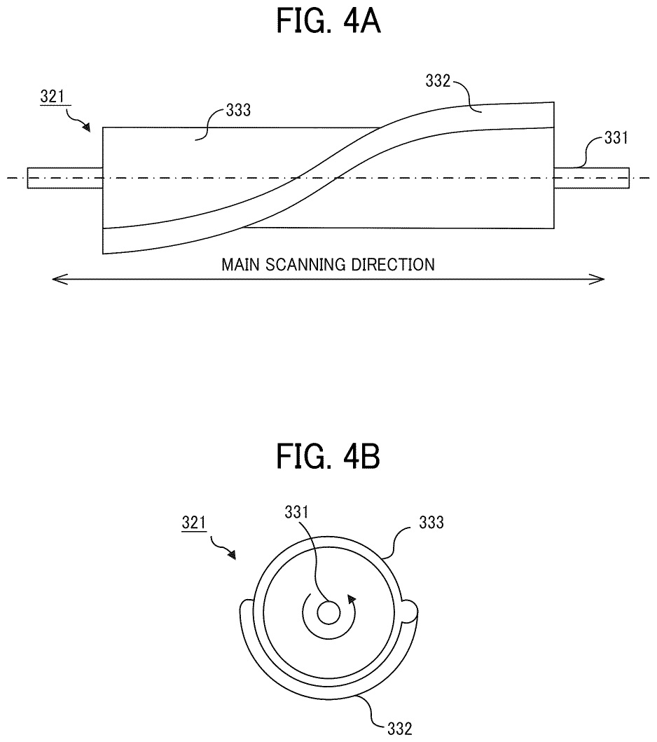

FIG. 4A and FIG. 4B are diagrams illustrating the fold-enhancing roller 321 provided for the folding apparatus 300.

FIG. 4A is a diagram illustrating the fold-enhancing roller 321 viewed in a direction orthogonal to the rotation axis, and FIG. 4B is a diagram illustrating the fold-enhancing roller 321 viewed in the rotation axis direction.

The fold-enhancing roller 321 has a pressing-force transmission roller 333, and a pressing-force transmission portion 332 with a convex shape is formed on the surface of the pressing-force transmission roller 333 having a certain difference in angle with the rotary shaft 331 of the fold-enhancing roller 321. As a result, the pressing-force transmission portion 332 is disposed extending in a spiral manner along the rotary shaft 331 of the fold-enhancing roller 321. As illustrated in FIG. 4B, the pressing-force transmission portion 332 is not laid out on the entire outer round surface of the pressing-force transmission roller 333, and is laid out on approximately the half of the outer round surface.

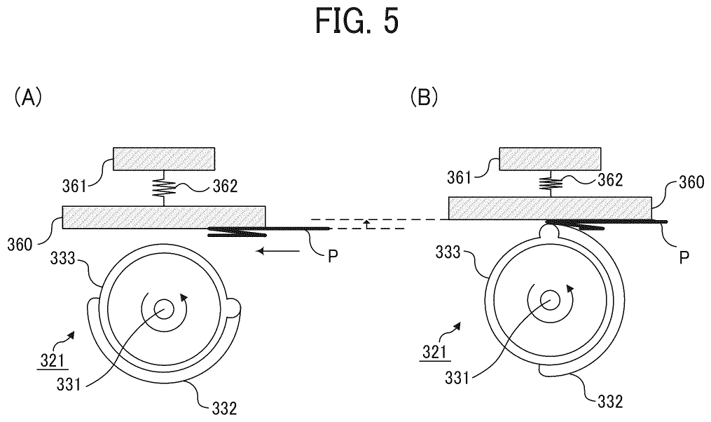

FIG. 5 is a diagram illustrating a fold-enhancing operation.

The folding apparatus 300 has a fixation member 361, and a sheet supporting plate 360 is attached to the fixation member 361 having an elastic body 362 therebetween that expands and contracts in the direction of the pressing force of the fold-enhancing roller 321. After the sheet P is conveyed from the position in (A) of FIG. 5 to the position in (B) of FIG. 5, the fold-enhancing roller 321 is driven to rotate in the direction indicated by arrows in FIG. 5. Accordingly, the pressing-force transmission portion 332 contacts the sheet P and pushes up the sheet supporting plate 360. The folded portion of the sheet P is pressed by the force of the elastic body 362. Due to such configurations as above, a fold-enhancing operation is implemented.

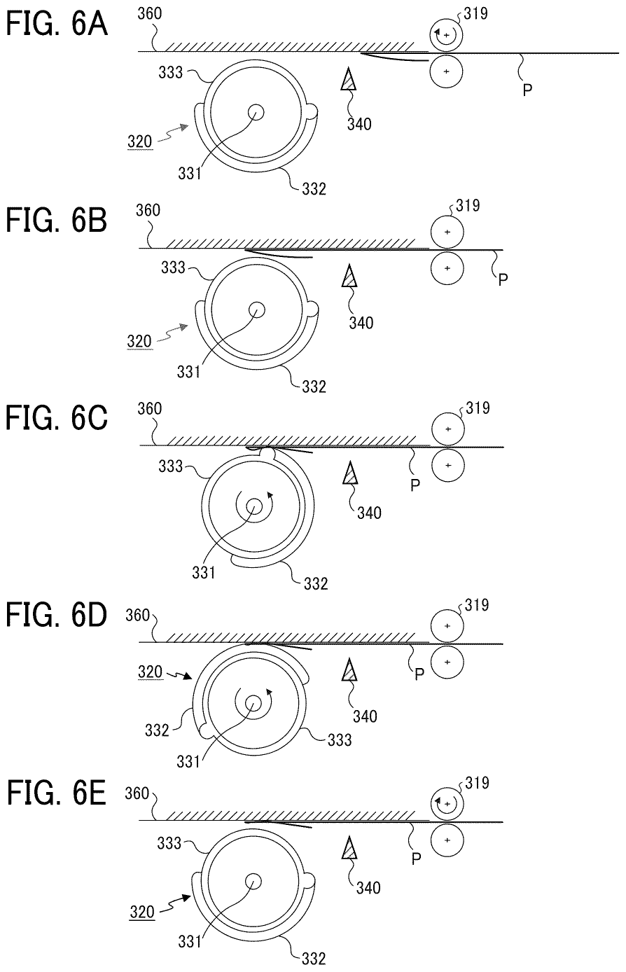

FIG. 6A, FIG. 6B, FIG. 6C, FIG. 6D, and FIG. 6E are diagrams illustrating a fold-enhancing operation and how such a fold-enhancing operation is controlled

In FIG. 6A, FIG. 6B, FIG. 6C, FIG. 6D, and FIG. 6E, the illustration in FIG. 3 is rotated by 90 degrees in the left direction to describe the conveyance path described above with reference to FIG. 3.

In FIG. 6A, the sheet P is being conveyed to a fold-enhancing device as the fifth conveyance roller 319 is driven to rotate. The CPU 371 measures an encoder signal indicating the revolutions per minute (rpm) of the conveyance motor 382 based on the timing at which the front end of the sheet P is detected by the fold-enhancing position sensor 340, and stops the conveyance motor 382 when a signal indicating that the front end of the sheet P has advanced and reached a position near the fold-enhancing roller 321 is measured. In response to that, as illustrated in FIG. 6B, the fifth conveyance roller 319 is stopped, and the sheet P is stopped at a processing position for fold-enhancing operation.

In FIG. 6C, a fold-enhancing motor 384 is driven to rotate and the fold-enhancing roller 321 starts rotating in the direction indicated by arrows in FIG. 6, and the pressing-force transmission portion 332 contacts the folded portion of the stopped sheet P. Accordingly, the fold-enhancing operation on the folded portion of the sheet P starts.

In FIG. 6D, the fold-enhancing roller 321 further rotates. When a fold-enhancing home position (HP) sensor that detects the home position (HP) of the fold-enhancing roller 321 detects the home position (HP) of the fold-enhancing roller 321 (and that the pressing-force transmission portion 332 has moved away from the sheet supporting plate 360 as illustrated in FIG. 6E), the fold-enhancing motor 384 is stopped as controlled by the CPU 371, and the fold-enhancing roller 321 stops rotating. This makes up one fold-enhancing operation.

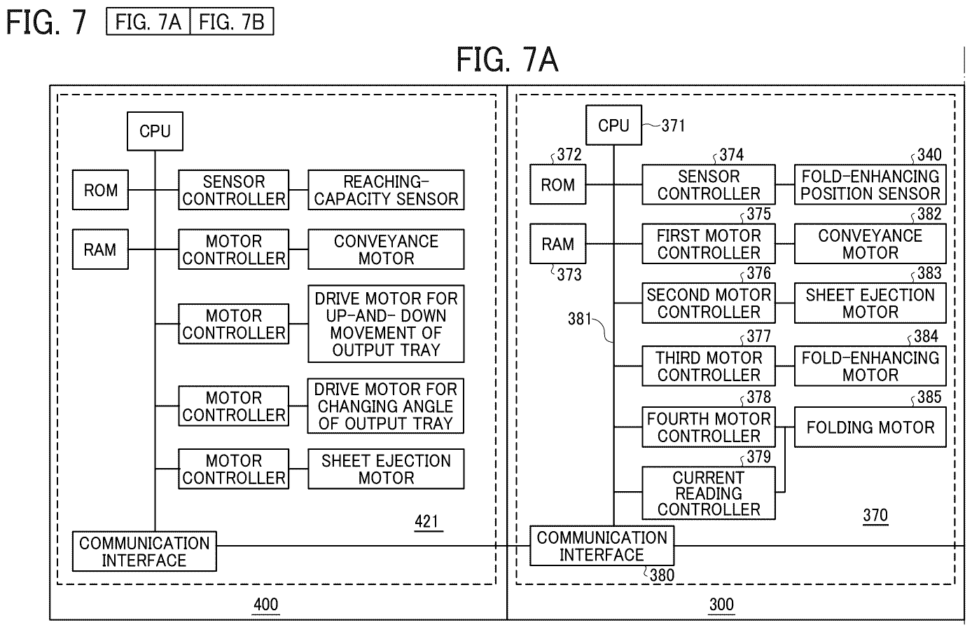

FIG. 7A and FIG. 7B (FIG. 7) are diagrams illustrating a hardware configuration of control blocks.

The configuration illustrated in FIG. 7A and FIG. 7B (FIG. 7) is a part of the configuration of the image forming system 1000, and is used for executing a specific control process.

In the control processes described below, a timing at which an output tray will be fully loaded is predicted in order to increase the stackability of the sheets P or the sheet bundle Pb stacked on an output tray. Accordingly, the control processes are executable by the control blocks of the image forming system 1000 including the image formation controller 118, the decurler control unit 219, the folding process controller 370, and the post-processing control unit 421. Cases in which control processes are performed by the folding process controller 370 are described below.

As illustrated in FIG. 7A and FIG. 7B (FIG. 7), the control blocks of the folding apparatus 300 include a central processing unit (CPU) 371, a read-only memory (ROM) 372, a random-access memory (RAM) 373, a sensor controller 374, a first motor controller 375, a second motor controller 376, a third motor controller 377, a fourth motor controller 378, a current reading controller 379, and a communication interface 380. These components or elements are electrically connected to each other through a bus line 381 such as data bus and an address bus.

The communication interface 380 communicates with the image forming apparatus 100 through the post-processing apparatus 400 and the decurler apparatus 200 to exchange data to be used for a controlling operation. The sensor controller 374 is coupled to the fold-enhancing position sensor 340 to monitor the detected state of the sheet P.

The first motor controller 375 controls operation of the conveyance motor 382 that is a motor to drive the fifth conveyance roller 319. The second motor controller 376 controls operation of the sheet ejection motor 383 that is a motor to drive the seventh conveyance roller 323 to rotate. The third motor controller 377 controls operation of the fold-enhancing motor 384 that is a motor to drive the fold-enhancing roller 321 to rotate. The fourth motor controller 478 controls operation of the folding motor 385 that is a motor to drive the folding roller 317 to rotate.

The current reading controller 379 is an analog-to-digital (A/D) converter that converts the value of current from analog data into digital data, and reads the value of current supplied to the folding motor 385. The CPU 371 executes a computer-readable program stored in the ROM 372 to control the processes in the folding apparatus 300. The ROM 372 stores, for example, data and control programs to be executed by the CPU 371. A random-access memory (RAM) 373 temporarily stores, for example, data when the CPU 371 executes a control program.

Training data 501 that is used to generate a learning model 500 is described below.

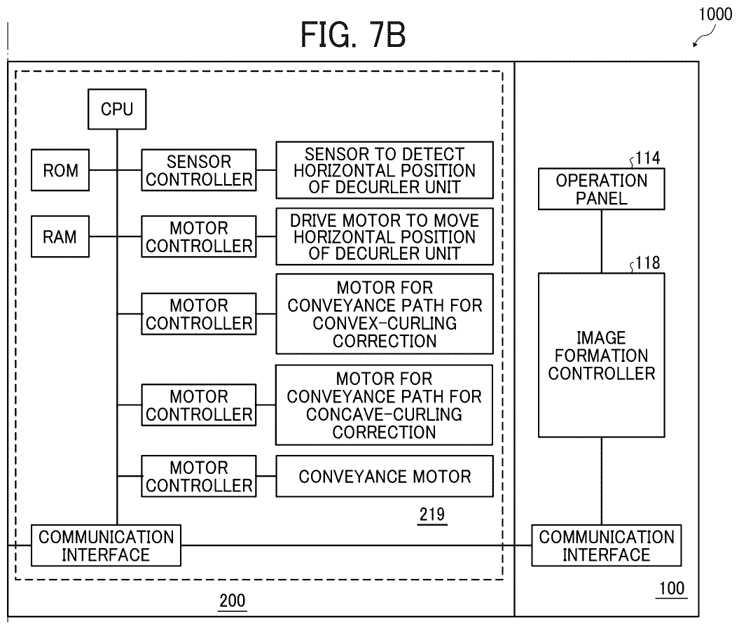

FIG. 8A, FIG. 8B, FIG. 8C, and FIG. 8D are diagrams illustrating several data groups obtained by summing up, in chronological order, the track record of the sheet ejection processes until the amount of the stacked media on each output tray reaches 100%.

FIG. 8A is a table indicating the training data 501 including the number of the stacked sheets P when the amount of the media stacked on the first post-processing output tray 423 reaches 100 percent and the order in which the sheets P are ejected. FIG. 8B is a table indicating the training data 501 including the number of the stacked sheets P when the amount of the media stacked on the second post-processing output tray 424 reaches 100 percent and the order in which the sheets P are ejected. FIG. 8C is a table indicating the training data 501 including the number of the stacked sheets P when the amount of the media stacked on the folding-device output tray 325 reaches 100 percent and the order in which the sheets P are ejected. FIG. 8D is a table indicating the training data 501 including the number of the stacked sheets P when the amount of the media stacked on the folding-device output tray 325 reaches 25 percent and the order in which the sheets P are ejected.

The training data 501 in each of FIG. 8A, FIG. 8B, FIG. 8C, and FIG. 8D is a data group, and what is executed by a series of jobs from a point in time where no sheet P is stacked on each of the output trays including the first post-processing output tray 423, the second post-processing output tray 424, and the folding-device output tray 325 to a point in time where each output tray is fully loaded and has reached its stacking limit is used as input data. Analytical processing is performed using the training data 501 as input data in the machine learning processes, and as a result, the learning model 500 is generated. Whether any one of the output trays has reached its stacking limit is determined based on whether each of the full-load sensor 402, the full-load sensor 406, and the full-load sensor 304 is turned on.

In other words, when the full-load sensor 402 is turned on, it is determined that the first post-processing output tray 423 is fully loaded. When the full-load sensor 406 is turned on, it is determined that the second post-processing output tray 424 is fully loaded. When the full-load sensor 304 is turned on, it is determined that the folding-device output tray 325 is fully loaded.

The training data 501 includes, for example, attribute information including, for example, a sheet size, a sheet type, and sheet thickness and the information about medium processing such as a type of post-processing operation, the number of sheets (or the number of copies), and the order in which jobs are executed, which are specified in a series of jobs from a point in time where each output tray is empty to a point in time where each output tray reaches its capacity.

The order in which jobs are executed is recorded with accuracy because there could be cases in which the sheets P that are ejected in the second half of the job may press the sheets P ejected in the first half and curved portions of the sheets P due to low resilience or low rigidity are pressed down (and vice versa).

As in the fourth training data 501d depicted in FIG. 8D, another learning model may be prepared using a series of jobs executed until the amount of the stacked media reaches 25% as the training data 501. In such cases, at predetermined ratio or percentage, the current amount of the sheets P stacked on each tray may be displayed on the display unit 113 provided for the image forming apparatus 100. For example, another learning model may be prepared using a series of jobs executed until the amount of the stacked media reaches 50% as the training data 501, or another learning model may be prepared using a series of jobs executed until the amount of the stacked media reaches 75% as the training data 501. Accordingly, the amount of stacked sheets on each output tray can be displayed in a more specific manner based on a more detailed level of percentage or ratio.

### First Embodiment of Control Processes with Learning Model

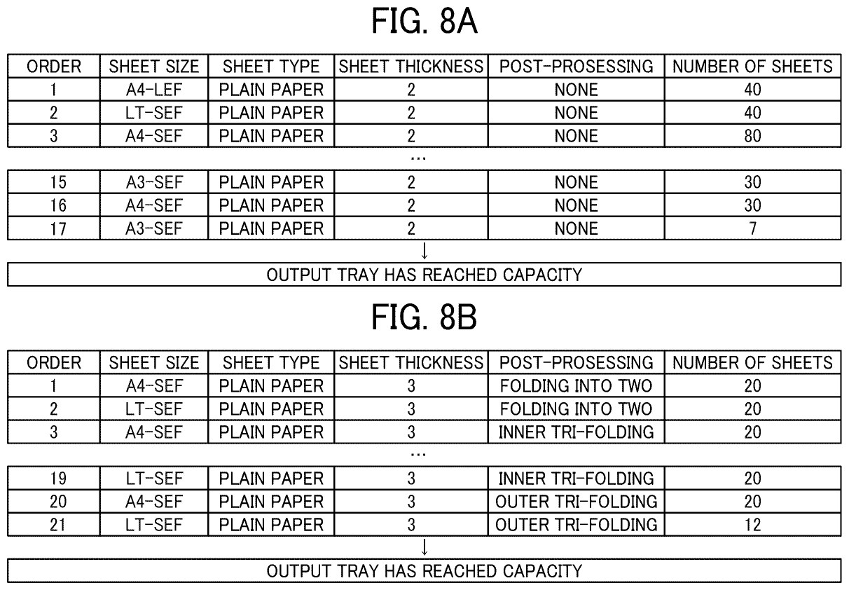

The control processes with the learning model 500, i.e., prediction that an output tray will reach its capacity according to a first embodiment, are described below with reference to the flowchart of FIG. 9. FIG. 9 is a flowchart of a control program, and a timing at which the folding-device output tray 325 reaches its capacity is predicted in such a control program. In a similar manner, such prediction can be performed for the first post-processing output tray 423 and the second post-processing output tray 424 of the post-processing apparatus 400.

The control processes as will be described later in detail are implemented by executing processing functions, and such processing function are implemented by the hardware resources of the folding process controller 370 and a control program executed using those hardware resources. The CPU 371 provided for the folding process controller 370 is an example of a setting changer to change what is to be controlled in the processes where what is controlled is optimized, which will be described later in detail.

Firstly, in step S901, a print job is set through the operation panel 114 coupled to the image forming apparatus 100 or an information processing device installed with a printer driver, and the print job is executed.

Subsequently, in step S902, whether the sheets P or the sheet bundle Pb are stacked on the folding-device output tray 325 is determined. Such a determination in step S902 is made by determining whether the full-load sensor 304 is turned on.

When the folding-device output tray 325 is empty (YES in step S902), in step S903, the recorded data of the sheets P in the past is reset. The data of print sheets that were handled in the past indicates the data of the sheets P used for all the image-forming jobs that have been executed up to now after the folding-device output tray 325 became empty and the medium sensor 303 was turned off.

When it is determined that the folding-device output tray 325 is not empty (NO in step S902) or after the data of print sheets that were handled in the past is reset in step S903, in step S904, a full-load prediction is performed. In step S904, whether the folding-device output tray 325 will reach its capacity in the current print job is predicted using the learning model 500 that refers to the print job that is currently executed and the recorded data of print sheets that were handled in the past. In other words, the amount of the sheets P stacked on each output tray is predicted using the learning model 500, and the timing of a stacking limit is predicted based on the predicted amount of stacked sheets. The processes in step S904 are executed by the full-load prediction unit that performs a series of processes in which the timing of a stacking limit is predicted using the learning model 500. In step S904, prediction is made as to with how many sheets P in the current print job the tray will be fully loaded.

Subsequently, in step S905, an image is formed on the first sheet P in the job that was first executed in step S901, and the sheet P is ejected.

In step S906 after the processes in step S905 are performed, whether the folding-device output tray 325 is fully loaded and whether the medium sensor 303 is turned on are determined. When the medium sensor 303 is turned on (YES in step S906), in step S907, whether the learning model 500 has predicted that the folding-device output tray 325 will reach its capacity in the ejection of the sheets P this time is determined. In actuality, a margin of 1 to 2% is set instead of determining that a predicted value is equal to a counted number of sheets, and whether the predicted value is within the value range including the set margin is determined.

When it is not predicted that the folding-device output tray 325 will reach its capacity in the ejection of the sheets P this time (NO in step S907), in step S908, whether the current number of the sheets P stacked on the folding-device output tray 325 is larger than the number of the sheets P with which it is predicted that the tray will be fully loaded is determined. When the current number of the sheets P stacked on the folding-device output tray 325 is not greater than the number of the stacked sheets P with which it is predicted that the tray will be fully loaded (NO in step S908), the medium sensor 303 is turned on despite the amount of stacked sheets that is smaller than the value predicted by the learning model 500. Under these circumstances, the output tray has reached its stacking limit at an earlier stage than the predicted timing of a stacking limit. Such circumstances may be expressed that a tray is fully loaded at an earlier stage or a tray has reached its capacity at an earlier stage.

When it is erroneously detected that a tray is fully loaded at an earlier stage, in step S909, what is to be controlled in the image-forming processes is optimized, and what is to be controlled in the printing operation is optimized. How the printing operation is optimized will be described later in detail.

When the learning model 500 has successfully predicted that the folding-device output tray 325 will reach its capacity in the ejection of the sheets P this time (YES in step S907), in step S910, the printing operation is stopped until the sheet P is removed from the folding-device output tray 325.

When the current number of the sheets P stacked on the folding-device output tray 325 is greater than the number of the stacked sheets P with which it is predicted that the output tray will reach its capacity (YES in step S908), the amount of stacked sheets is greater than the value predicted by the learning model 500, and it can be determined that the output tray has not erroneously reached its capacity at an earlier stage. Accordingly, in step S910, the printing operation is ended until the sheet P is removed from the folding-device output tray 325.

When the printing job is not all completed after the sheet P is removed from the folding-device output tray 325 (NO in step S911), the process is returned to step S905, and the relevant processes are repeated. When the printing job is all completed (YES in step S911), in step S912, the data on the print sheets that were handled this time is added to the recorded data of the print sheets that were handled in the past, and this series of processes is terminated.

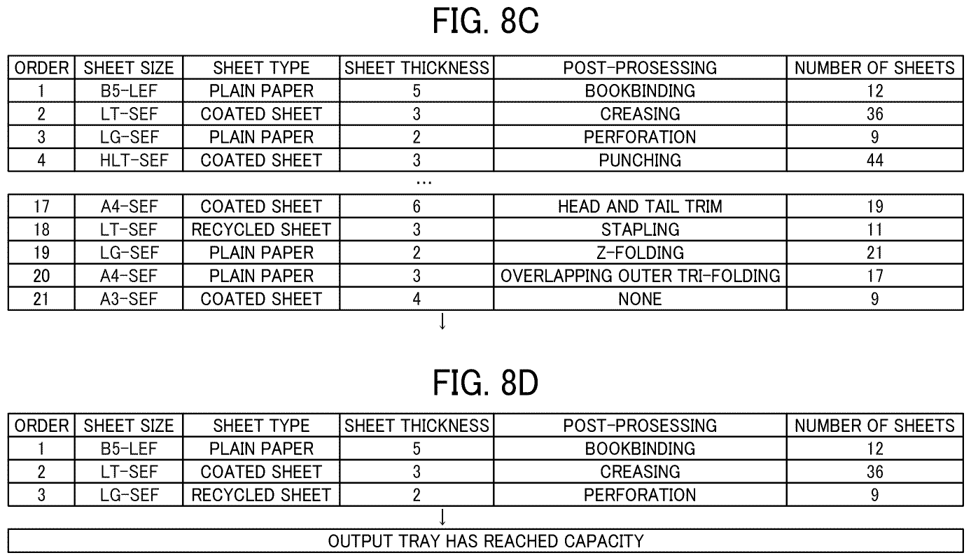

The usage of the learning model 500, which is generated by machine learning of prediction that an output tray will reach its capacity where what is executed by a series of jobs is used as input data, is described below with reference to FIG. 10A and FIG. 10B. FIG. 10A illustrates a case in which the sheets P of varying sheet sizes or the sheets P that have gone through a post-processing operation are stacked on a single tray. FIG. 10A illustrates the cases of the folding-device output tray 325. However, no limitation is indicated thereby, and the cases of the folding-device output tray 325 are applicable to the first post-processing output tray 423 and the second post-processing output tray 424.

FIG. 10B illustrates a vertical output tray such as a vertically-stacking output tray 9 for an automatic laminator.

When a vertical output tray is adopted, it is not easy to predict the timing at which the tray reaches its capacity simply based on the data such as the number of sheets or the thickness of the sheets. In the case of an apparatus having a vertical stack as illustrated in FIG. 10B, elements such as a mechanism to support the stacked sheets P with a pressing member 10 for the sheets ejected from an automatic laminator and a sensor that detects a full-load condition like a full-load sensor 11 provided for the vertically-stacking output tray 9 for the automatic laminator are included.

FIG. 10A illustrates a single output tray on which a plurality of sheets P of varying sheet sizes that have gone through a post-processing operation such as Z-folding, outer tri-folding, creasing, and folding into two are stacked. As described above, when the sheets P of varying sheet sizes or the sheets P that have gone through a post-processing operation are stacked on a single output tray, how these sheets P are stacked on top of each other has a wide variety, and the combinations thereof is enormous. However, the arrangement of a plurality of detection units such as feelers or sensors to figure out how the sheets P are stacked correctly could be barriers to reduction in size or cost.

Even if various combinations of jobs are tried at the stage of design, it is difficult for a human to figure out all the regularity and the interaction among the sheets. For example, a relatively heavy sheet P presses a relatively light sheet P depending on the type of sheets, the sheet thickness, and the number of sheets. For example, the sheets P of varying sizes are stacked on top of each other, and the sheets P are displaced with slight slipping or droppage.

In order to handle such a situation, the training data 501 is used to predict a time at which an output tray is fully loaded, and the learning model 500 which is generated by machine learning is used. Accordingly, the accuracy of prediction that an output tray will reach its capacity increases.

In FIG. 10B, the sheets P are stacked at oblique angles, where the angle of stacking is nearly vertical, and the pressing member 10 for the sheets ejected from an automatic laminator moves in order to reduce the curling or errors in stacking on a constant basis and press down the sheet bundle Pb.

Even if sheet information such as the type of the sheet P, the thickness of the sheet P, the size of the sheet P, and the number of the sheets P ejected under simply flat environments is available with which the total height of the sheets P can be calculated, it is difficult to predict the timing at which the output tray reaches its capacity depending on the stacking environments unique to the model. There are varying output trays or stackers depending on the model. When what is executed by a series of jobs in that model by the time the output tray reaches its capacity is used as the training data 501 to generate the learning model 500, the accuracy of prediction becomes high.

The optimization as described above with reference to step S909 of FIG. 9 with the use of the learning model 500 described above with reference to FIG. 8A, FIG. 8B, FIG. 8C, FIG. 8D, and FIG. 9 is described below. In other words, how the printing operation when it is determined in the image forming system 1000 that the output tray has reached its capacity at an earlier stage is optimized is described below.

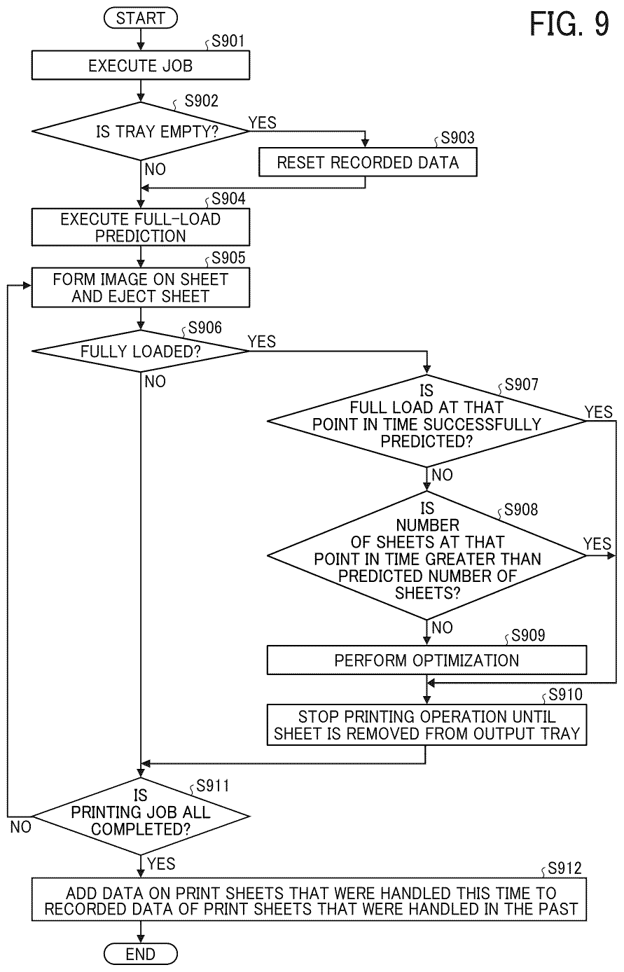

FIG. 11 is a schematic diagram of a decurler apparatus 200.

When it is determined that the output tray has reached its capacity at an earlier stage, the stackability could be increased by performing curling correction with the decurler apparatus 200.

As illustrated in FIG. 11, the decurler apparatus 200 is provided with a decurler unit 210. In other words, the decurler apparatus 200 is provided with a decurler roller 211, an upper pressure roller 212, and a lower pressure roller 213. Regarding the hardness of those two kinds of rollers, the decurler roller 211 is relatively soft, and the upper pressure roller 212 and the lower pressure roller 213 are relatively hard.

The upper pressure roller 212 and the lower pressure roller 213 are strongly pushed against the decurler roller 211, and the decurler roller 211 becomes depressed and is deformed. Accordingly, the conveyance path on the upper pressure roller 212 side reduces the convex curling of the sheet P, and the conveyance path on the lower pressure roller 213 side reduces the concave curling of the sheet P.

When one of the convex curling or the concave curling is to be corrected, the curl sensor 107 provided for the image forming apparatus 100 located upstream from the decurler apparatus 200 is used. The curl sensor 107 is at a position where the sheet P is ejected from the image forming apparatus 100. When no curling correction is to be performed, the decurler apparatus 200 conveys the sheet P through a straight path.

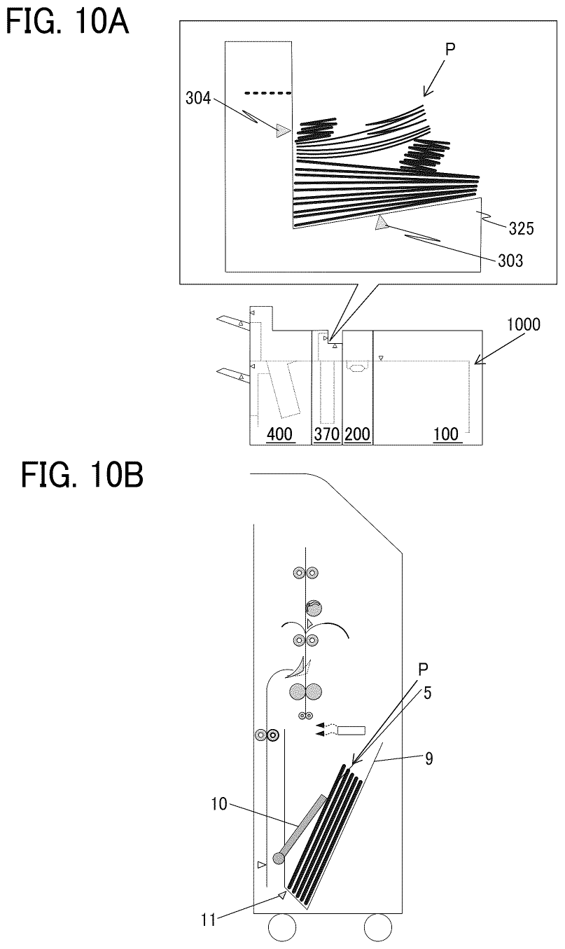

FIG. 12A and FIG. 12B are diagrams illustrating how the path of the decurler apparatus 200 is switched to change the correcting direction of curl.

The entire mechanism of the decurler apparatus 200 as illustrated in FIG. 11 is movable in the vertical direction relative to the image forming apparatus 100. As illustrated in FIG. 12A, when the decurler unit 210 has moved upward relative to the image forming apparatus 100, the sheet P passes through a lower path, and the concave curling can be corrected. As illustrated in FIG. 12B, when the decurler unit 210 has moved downward relative to the image forming apparatus 100, the sheet P passes through an upper path, and the convex curling can be corrected. In other words, whether to receive the sheet P in the upper conveyance path on the upper pressure roller 212 side or the lower conveyance path on the lower pressure roller 213 side is changeable.

As elements contributing to the curling correction of the sheet P, an operational change such as a reduction in the fixing temperature or the length of time at the fixing nip of the fixing device 117 of the image forming apparatus 100 may be adopted. Such an operational change is also effective in reducing the curl on the sheet P. The stackability could also be increased by increasing the number of times the folding apparatus 300 performs the fold-enhancing operation. Alternatively, changes such as adjustment in the positions of fold enhancement are also effective in handling an insufficient folding operation.

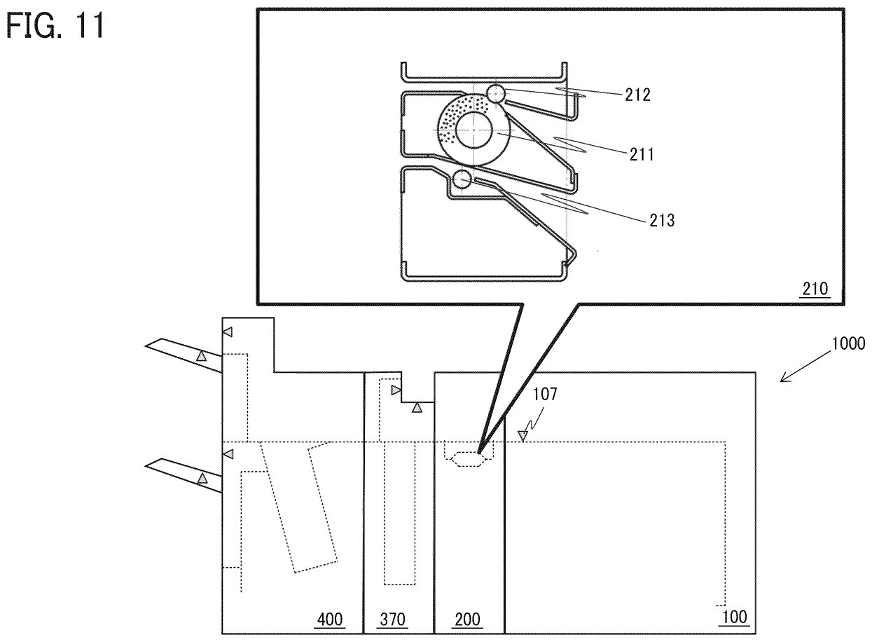

How the stackability is increased by changing the linear velocity in sheet ejection is described below with reference to FIG. 13A and FIG. 13B. FIG. 13A and FIG. 13B illustrate the cases of the folding-device output tray 325. However, no limitation is indicated thereby, and the cases of the folding-device output tray 325 are applicable to the first post-processing output tray 423 and the second post-processing output tray 424.

As illustrated in FIG. 13A, a sheet-ejection linear velocity a that indicates the ejection speed when the sheet P is ejected to the folding-device output tray 325 is assumed. As illustrated in FIG. 13B, another sheet-ejection linear velocity b that indicates the ejection speed when the sheet P is ejected to the folding-device output tray 325 is assumed. In the following description, it is assumed that the sheet-ejection linear velocity b is higher than the sheet-ejection linear velocity a. Under such an assumption, when the linear velocity in sheet ejection is low as illustrated in FIG. 13A, the stackability may be affected. By contrast, when the linear velocity in sheet ejection is high as illustrated in FIG. 13B, the stackability is not affected. For this reason, when the stackability is low and it is determined in an unintentional manner that the output tray has reached its capacity at an earlier stage with a number of sheets smaller than the stacking limit, the stackability may increase by adjusting the linear velocity in sheet ejection appropriately.

### First Embodiment of Control Processes

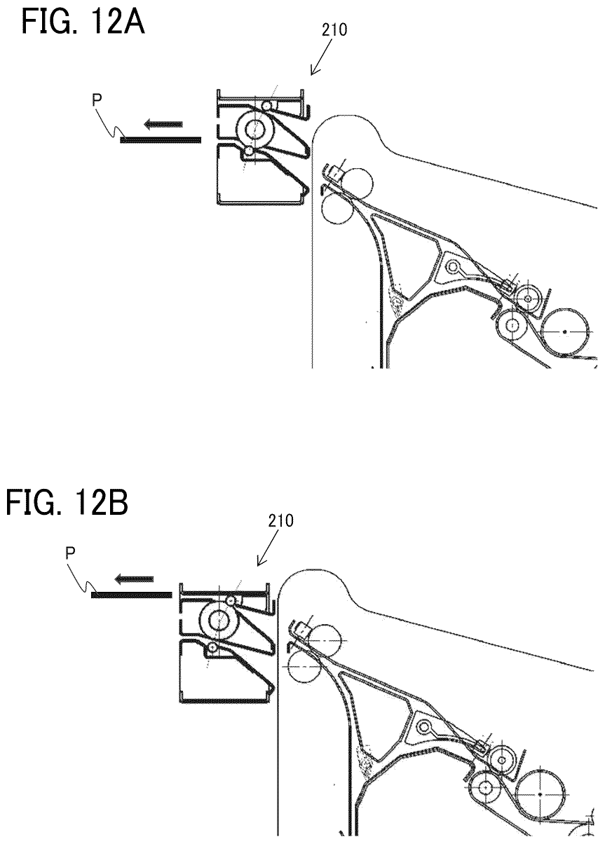

Control processes according to a first embodiment are described below with reference to the flowchart of FIG. 14.

FIG. 14 is a diagram illustrating the control processes executable by the post-processing apparatus 400 and the folding apparatus 300 that is an example of a medium processing apparatus.

In the control processes described below, the timing at which the folding-device output tray 325 provided for the folding apparatus 300 reaches its capacity is predicted to increase the stackability. The control processes as will be described later in detail may be implemented by the first post-processing output tray 423 and the second post-processing output tray 424 of the post-processing apparatus 400. In the following description, the first post-processing output tray 423, the second post-processing output tray 424, and the folding-device output tray 325 may collectively be referred to as an output tray.

When the sheet P on which an image has been formed by the image forming apparatus 100 is conveyed to the folding-device output tray 325 and it is predicted in step S908 of FIG. 9 that the output tray will be fully loaded at an earlier stage (YES in step S1401), in step S1402, whether any one of the sheets P or the sheet bundle Pb stacked on the folding-device output tray 325 has been folded is determined.

When it is determined that some of the sheets P or the sheet bundle Pb has been folded (YES in step S1402), in step S1403, curling correction is performed on the sheet P in the printing processes or image-forming processes to be executed next in the current set of jobs in progress.

When it is determined that none of the sheets P or the sheet bundle Pb has been folded (NO in step S1402), in step S1404, the number of fold-enhancing operations by the folding apparatus 300 is increased in the printing processes or image-forming processes to be executed next in the current set of jobs in progress.

When it is not predicted that the output tray will be fully loaded at an earlier stage (NO in step S1401), the settings for the image-forming operation are not adjusted.

The control processes described above with reference to FIG. 14 can be optimized for the purposes of increasing the stackability when it is determined that the output tray has reached its capacity at an earlier stage. What kind of optimization is most effective as adjustment in settings is determined based on the type of post-processing operation that is being executed when it is determined that the output tray has reached its capacity at an earlier stage. The type of post-processing operation can be automatically determined based on the history as to what has been executed on the sheets P stacked on a sheet tray by a series of jobs.

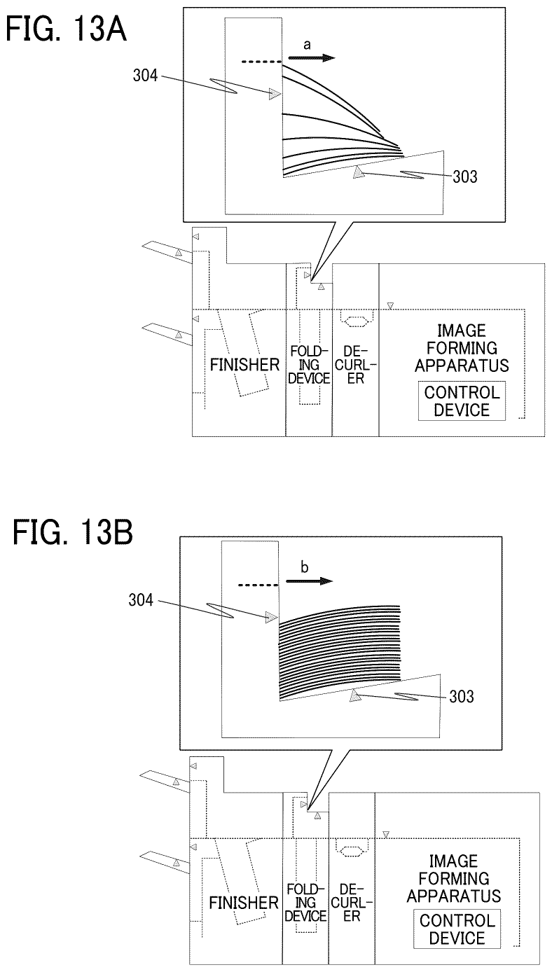

FIG. 15 illustrates a first example of an interface where control settings can be freely selected by a user for the purposes of increasing the stackability.

The change setting screen G1 illustrated in FIG. 15 is a user interface (UI) displayable on the display unit 113 provided for the image forming apparatus 100, and user selection data can be selected by manipulating or pressing down an operation key on the change setting screen G1 through the operation panel 114.

As illustrated in FIG. 15, the change setting screen G1 is displayed on the display unit 13 provided for the image forming apparatus 100 and waits for a user to make selection in the optimization of the printing operation in step S909 of FIG. 9. In step S909, the process goes on standby until manipulations are made through the change setting screen G1 to determine the user selection data.

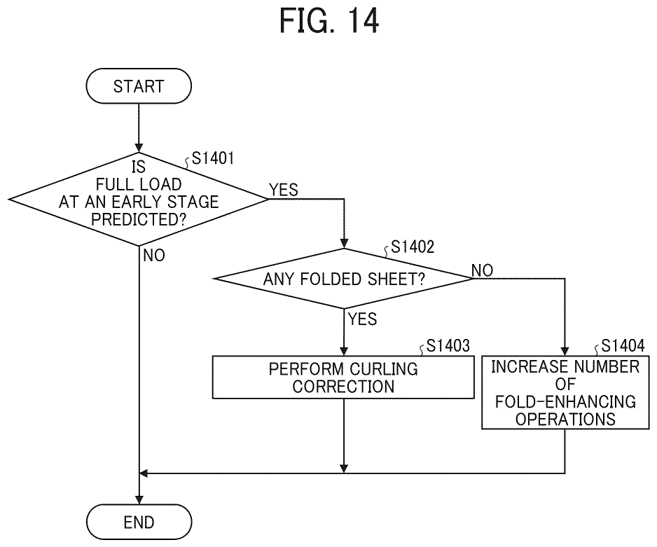

FIG. 16 illustrates a second example of a user interface (UI) where operation settings can be freely selected in the optimization in step S909 of FIG. 9 to be performed when a full load at an early stage is detected, for the purposes of increasing the stackability and maintaining the productivity.

When it is detected that an output tray has reached its capacity at an early stage, the printing operation can be continued through an operation on a select setting screen G2 is illustrated in FIG. 16 without removing the sheets P or the sheet bundle Pb stacked on the output tray. When it is detected that the output tray has reached its capacity at an earlier stage, the printing operation is stopped, and the printing operation can be kept on standby until the sheet P or the like is removed from the output tray that is detected to be fully loaded.

As in the select setting screen G2 illustrated in FIG. 16, the continuation of the printing operation can be selected, and a selection not to perform a full-load detection can be made. Due to such a configuration, when the output tray has not reached its capacity in actuality, the printing operation can be continued without stopping a conveyor, ignoring the detection that the output tray has reached its capacity. In this respect, the productivity can be increased.

In cases where it is erroneously detected at an earlier stage that an output tray has reached its capacity due to low stackability and the printing operation is stopped in an unintentional manner, depending on the model, a user can be supported by changing the control in this manner.

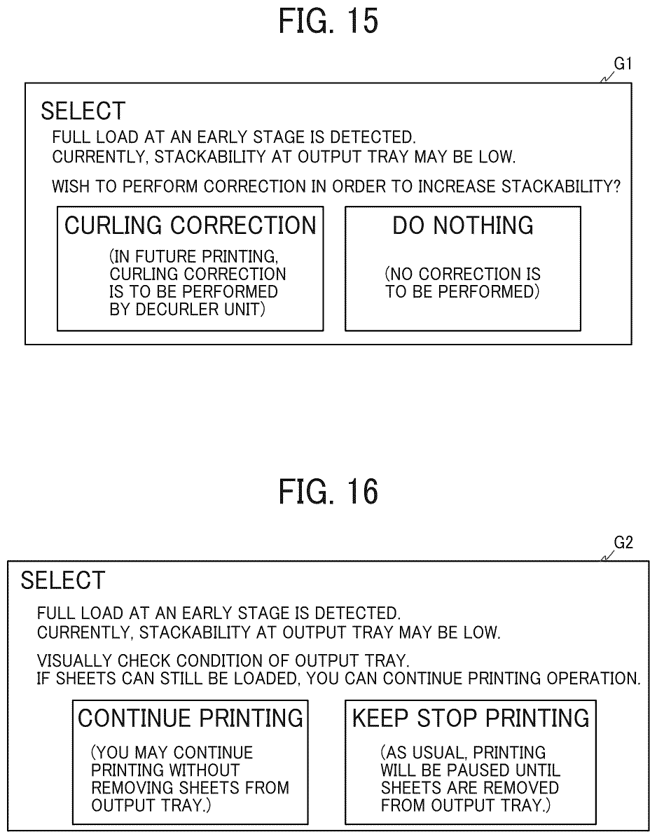

The control processes according to the second embodiment are described below with reference to FIG. 17A, FIG. 17B, FIG. 17C, FIG. 17D, FIG. 17E, and FIG. 17F. These control processes according to the present embodiment are applicable to second post-processing output tray 424.

FIG. 17A, FIG. 17B, FIG. 17C, FIG. 17D, FIG. 17E, and FIG. 17F are diagrams illustrating the lifting and lowering movement executable at the second post-processing output tray 424.

As illustrated in FIG. 17A, the full-load sensor 406 that detects the top-end position of stacked objects such as the sheets P and the sheet bundle Pb stacked on the second post-processing output tray 424 is provided. When the full-load sensor 406 is turned on, the second post-processing output tray 424 has reached its capacity with stacked objects.

As illustrated in FIG. 17B, when the second post-processing output tray 424 has reached its capacity, the second post-processing output tray 424 is moved downward to accept more stacked objects. Due to such operations, as illustrated in FIG. 17C, the second post-processing output tray 424 can move downward to a lower limit.

As illustrated in FIG. 17D, when the second post-processing output tray 424 is lowered to a lower limit and the full-load sensor 406 is turned on, as illustrated in FIG. 17E, the stacked objects need to be removed from the second post-processing output tray 424.

Subsequently, as described with reference to FIG. 17F, the second post-processing output tray 424 is moved upward to a point where the full-load sensor 406 is turned on.

If some of, for example, the sheets P stacked on an output tray is removed, typically, such removal cannot be detected, and the timing at which the output tray will reach its capacity cannot accurately be predicted. However, if mechanisms to detect that some of the sheets P have been removed from the tray and the height of those removed sheets P are provided as for the second post-processing output tray 424, such partial removal of the sheets P or the like can appropriately be handled.

As in the second post-processing output tray 424 illustrated in FIG. 17A, FIG. 17B, FIG. 17C, FIG. 17D, FIG. 17E, and FIG. 17F, if a configuration is adopted in which the second post-processing output tray 424 is lifted or lowered depending on the number of stacked sheets, the amount of movement of a motor may be used, and the jobs with which a certain number of sheets P have been ejected and the height of the tray at that moment in time may be stored on an as-needed basis. By subtracting what is executed on the removed sheets P or the like by a series of jobs from the amount of rise of the second post-processing output tray 424 due to the removal of some of the sheets P stacked on the second post-processing output tray 424, in view of the list of the jobs executed in the past, which is recorded for the machine learning, the timing at which the output tray will reach its capacity can continuously be predicted with a high degree of precision.

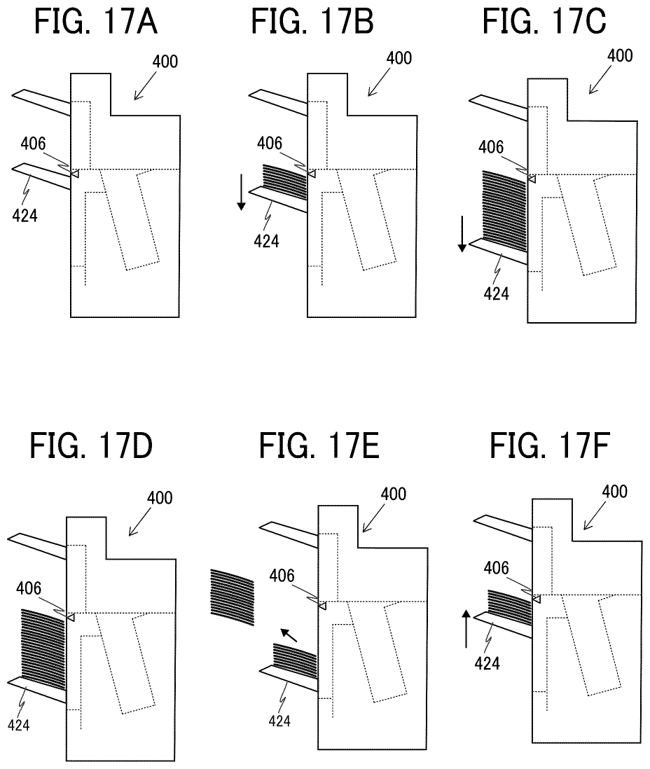

FIG. 18 is a diagram illustrating an output-tray elevating mechanism 430 that is an example of a position changer to lift or lower the second post-processing output tray 424 that is an example of a stacking tray to change the position.

The output-tray elevating mechanism 430 is provided with a guide 431 and a roller unit 433, and a motor is driven to rotate to rotate a belt 432. As a result, the second post-processing output tray 424 is lifted or lowered along the guide 431. The control processes described above with reference to FIG. 17A, FIG. 17B, FIG. 17C, FIG. 17D, FIG. 17E, and FIG. 17F can be performed as the belt 432 is rotated based on the results of the detection performed by the full-load sensor 406.

As in the second post-processing output tray 424, even if some of the stacked objects is removed, when the output tray will be fully loaded can be predicted. Due to such a configuration, the timing at which the output tray will reach its capacity can be predicted with a high degree of precision.

### Third Example of User Interface

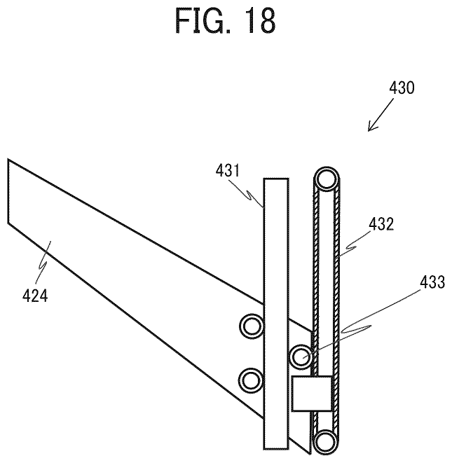

FIG. 19 is a diagram illustrating a user interface (UI) to notify a user of the amount of the media stacked on an output tray.

When the timing at which the output tray reaches its capacity can be predicted in the control processes described as above with reference to the flowchart of FIG. 9, the learning model 500 is generated such that the ratio or percentage of the current number of sheets stacked on each output tray to the stacking limit can be predicted. Accordingly, as on a load-amount prediction screen G3 depicted in FIG. 19, without newly installing a dedicated sensor or a detection mechanism such as a feelers, at the time of starting the job, a user can be notified of how much the current number of stacked sheets is relative to the stacking limit.

It is desired that the training data 501 to generate the learning model 500 with which the ratio of the current number of stacked sheets to the stacking limit can be predicted be prepared so as to be a given ratio or percentage such as 25%, 50%, and 75% relative to the stacking limit of each output tray. It is desired that the training data 501 be analyzed to generate the learning model 500. As the load-amount prediction screen G3 is displayed on the display unit 113 of the image forming apparatus 100, a user can figure out the number of sheets stacked on the tray in a timely manner.

### Fourth Example of User Interface

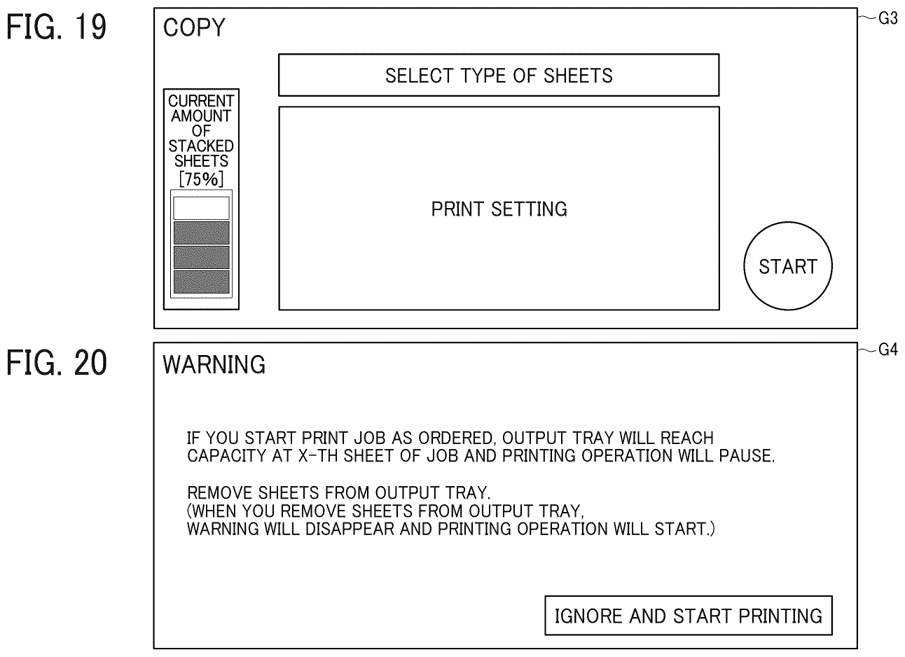

FIG. 20 is a diagram illustrating a full-load prediction screen G4 that is an example of a notifying device to warn at the time of selection of a print job by a user that the output tray will reach its capacity while the selected job is being executed.

Even when the execution of a job is not yet started, the full-load prediction screen G4 illustrated in FIG. 20 is displayed on the display unit 113 when it is successfully predicted that the output tray will reach its capacity by the job currently selected using the learning model 500. When the full-load prediction screen G4 is displayed and the printing operation is stopped on a temporary basis, a user can select “ignore and start printing” where appropriate to start the printing.

The timing at which the full-load prediction screen G4 is displayed on the display unit 113 is the timing at which the full-load prediction in step S904 described above with reference to FIG. 9 is executed.

### Second Embodiment of Learning Model Generation

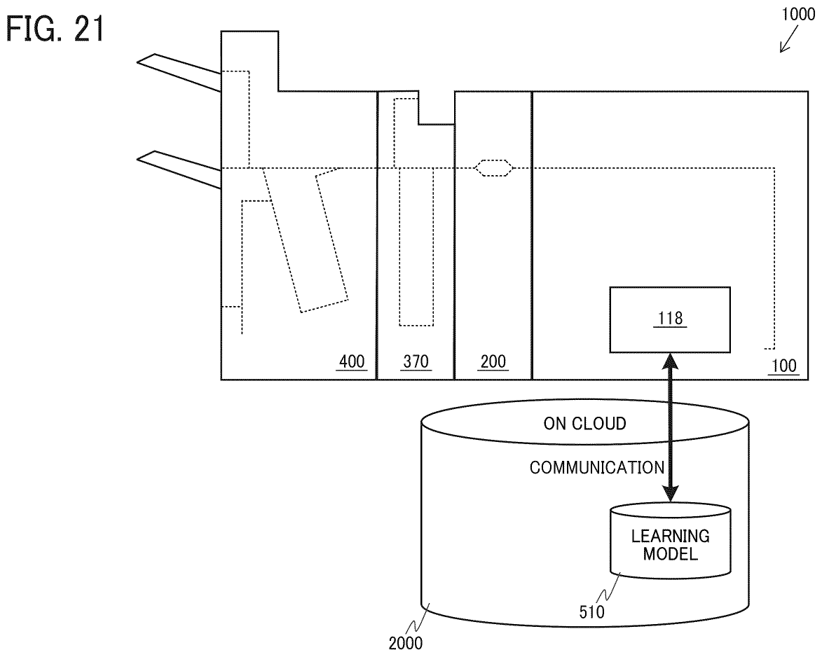

FIG. 21 is a diagram illustrating an external cloud system 2000 external to the image forming system 1000, storing the learning model 500 generated through the machine learning processes.

The learning model 500 is stored on the cloud system 2000, and prediction can be made using the learning model 500 on the cloud system 2000 through the communication network when a timing at which an output tray will be fully loaded is to be predicted in the image forming system 1000.

### Third Embodiment of Control Processes

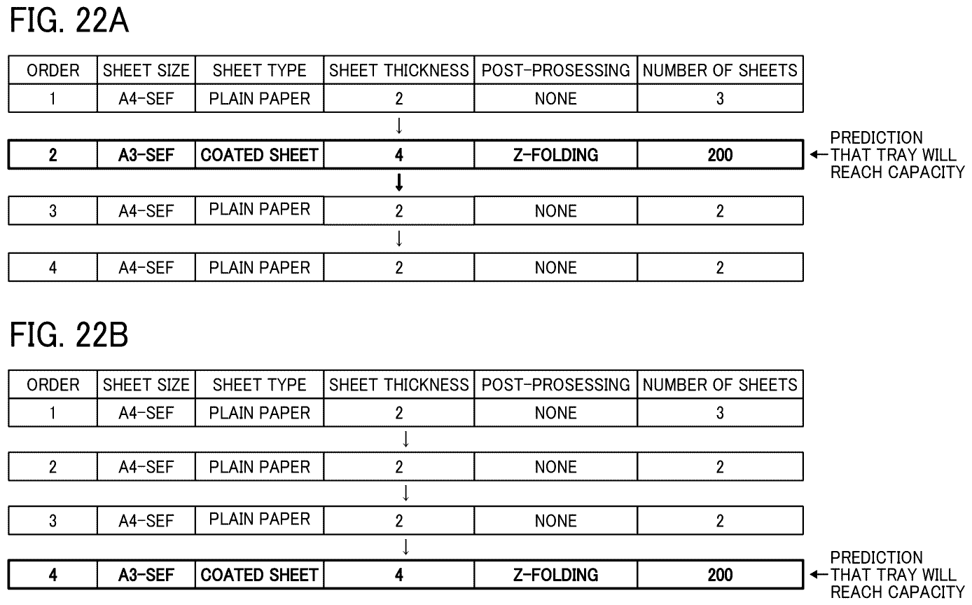

Control processes according to a third embodiment are described below with reference to FIG. 22A and FIG. 22B.

FIG. 22A and FIG. 22B are diagrams each of which illustrates a table of data, where a series of jobs indicating what is to be done onto the sheet P, which are stored in, for example, the RAM 373 that is an example of a memory, are listed in chronological order.

The efficiency of what is done by the jobs can be increased by changing the order in which a plurality of jobs are held and registered in the RAM 373 as illustrated in FIG. 22A and FIG. 22B.

Typically, a plurality of jobs are executed in the order listed. However, no limitation is indicated thereby, and FIG. 22A and FIG. 22B depict cases in which the timing of a stacking limit when the jobs are selected and executed in the order listed is predicted and the order in which the jobs are executed with the predicted timing is changed. By so doing, the number of completed jobs increases.

As in FIG. 22A, a case where four print jobs are registered is assumed. Under such an assumption, it is predicted that the output tray will be fully loaded in the print job of the order “2.” In the control processes according to the present embodiment, as illustrated in FIG. 22B, the print job of the order “2” is moved to the order “4”. In other words, when there is a job with which it is predicted that the output tray will be fully loaded, the job with which it is predicted that the output tray will be fully loaded is moved to the last job.

Among a plurality of print jobs sequentially registered by a user, whether there is a job with which it is predicted that the output tray will reach its capacity during that job is determined. When it is predicted that the output tray will reach its capacity during a particular job, the order in which the jobs are executed is changed or switched such that a job that is registered later will be executed earlier. As described above, for example, if the time at which a job to form the sheet bundle Pb is executed is changed, the output tray can be prevented from reaching its capacity with the sheet bundle Pb that is being formed, and the ejection of an incomplete sheet bundle Pb in a wasteful manner can be prevented.

### Fourth Embodiment of Control Processes

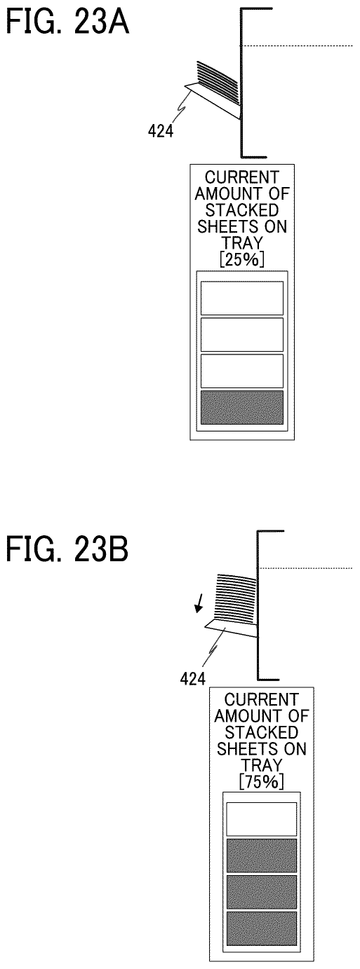

Control processes according to a fourth embodiment are described below with reference to FIG. 23A and FIG. 23B. In the present embodiment described with reference to FIG. 23A and FIG. 23B, the position of the second post-processing output tray 424 in the lifting and lowering direction is made variable, and the position at which the ejected sheets P are received is changed. Accordingly, the sheets can be stacked appropriately in view of the amount of the media stacked on the second post-processing output tray 424.

For example, it is assumed that the prediction on the amount of the sheets P stacked on the second post-processing output tray 424 is changed from 25% as illustrated in FIG. 23A to 75% as illustrated in FIG. 23B.

Under such an assumption, the second post-processing output tray 424 is moved downward when it is predicted that the amount of the stacked media has reached 75%. Accordingly, the ejected sheets P or the ejected sheet bundle Pb can be stacked appropriately. In other words, the prediction of the time at which the output tray reaches its capacity is applied, and the position of the second post-processing output tray 424 can be changed when the ratio or percentage of the amount of the sheets P stacked on the second post-processing output tray 424 relative to the stacking limit has changed. Accordingly, the sheets P can be stacked appropriately.

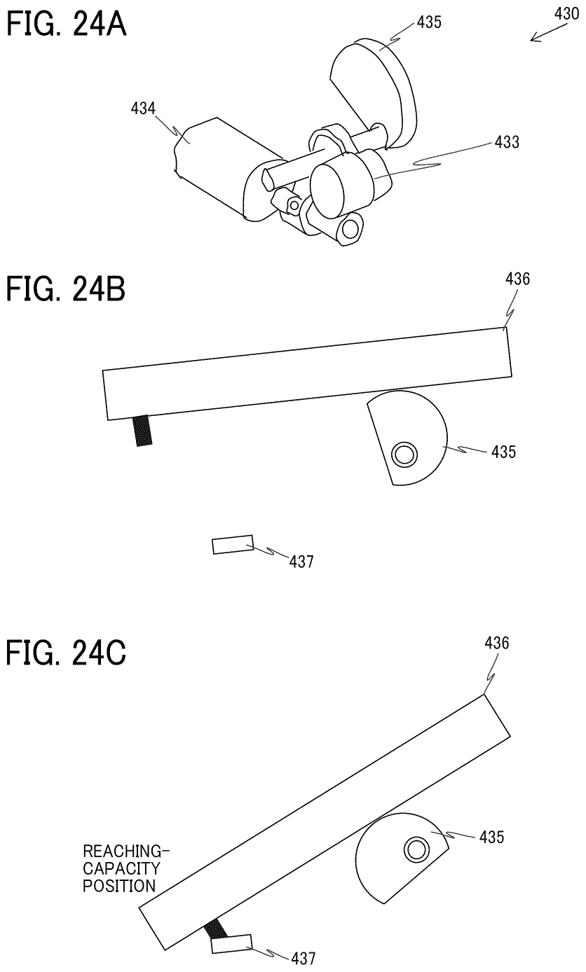

A configuration or structure of the output-tray elevating mechanism 430 that changes the position of the second post-processing output tray 424 as illustrated in FIG. 23A and FIG. 23B is described below with reference to FIG. 24A, FIG. 24B, and FIG. 24C. As described above with reference to FIG. 18, the output-tray elevating mechanism 430 is supported so as to be lifted or lowered along the guide 431 by driving the belt 432 to rotate. The driving force to rotate the belt 432 is supplied from the output-tray lifting and lowering motor 434. As the roller unit 433 that contacts the rotary shaft of the output-tray lifting and lowering motor 434 conveys the rotational power of the output-tray lifting and lowering motor 434 to the belt 432, the second post-processing output tray 424 is lifted or lowered.

As illustrated in FIG. 24A, the rotation of the output-tray lifting and lowering motor 434 is conveyed to the output-tray lifting and lowering cam 435 through the roller unit 433.

As illustrated in FIG. 24B, the output-tray lifting and lowering cam 435 rotates as the output-tray lifting and lowering motor 434 is driven to rotate. As the output-tray lifting and lowering cam 435 rotates, the height of the feeler 436 changes. When the feeler 436 is lowered to a certain extent, as illustrated in FIG. 24C, the feeler 436 contacts an ejection lower-limit sensor 437, and it is detected that the second post-processing output tray 424 has reached the lower limit.

As described above, the position of the second post-processing output tray 424 is changed in accordance with the rotation of the output-tray lifting and lowering motor 434, and the ratio or percentage relative to the lower limit can be indicated explicitly.

### Second Embodiment of Control Processes with Learning Model

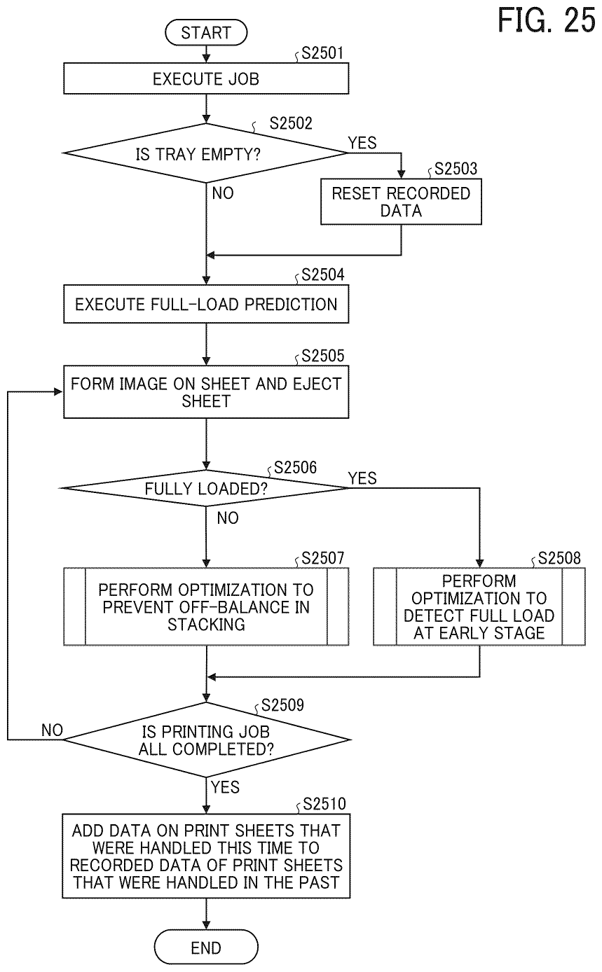

The control processes with the learning model 500 are described below with reference to FIG. 25. More specifically, control processes when the full-load sensor 304 is not turned on despite the fact that the predicted timing at which the output tray will be fully loaded has come are described.

Firstly, in step S2501, a print job is set through the operation panel 114 coupled to the image forming apparatus 100 or an information processing device installed with a printer driver, and the print job is executed.

Subsequently, in step S2502, whether the sheets P or the sheet bundle Pb are stacked on the folding-device output tray 325 is determined. Such a determination in step S2502 is made by determining whether the full-load sensor 304 is turned on.

When the folding-device output tray 325 is empty (YES in step S2502), in step S2503, the recorded data of the sheets P in the past is reset. The data of print sheets that were handled in the past indicates the data of the sheets P used for all the image-forming jobs that have been executed up to now after the folding-device output tray 325 became empty and the medium sensor 303 was turned off.

When it is determined in step S2502 that the folding-device output tray 325 is not empty (NO in step S2502) or after the data of print sheets that were handled in the past is reset in step S2503, in step S2504, a full-load prediction is performed. In step S2504, whether the folding-device output tray 325 will reach its capacity in the current print job is predicted using the learning model 500 that refers to the print job that is currently executed and the recorded data of print sheets that were handled in the past. In step S2504, prediction is made as to with how many sheets P in the current print job the tray will be fully loaded.

Subsequently, in step S2505, an image is formed on the first sheet P in the job that was first executed in step S2501, and the sheet P is ejected.

In step S2506 after the processes in step S2505 are performed, whether the folding-device output tray 325 is fully loaded and whether the medium sensor 303 is turned on are determined. When the medium sensor 303 is not turned on (NO in step S2506), in step S2507, optimization to prevent off-balance in stacking is performed. When the medium sensor 303 is turned on (YES in step S2506), in step S2508, optimization to detect full load at early stage is performed.

How to perform optimization to prevent off-balance in stacking in step S2507 and how to perform optimization to detect full load at an early stage in step S2508 are described later in detail.

When the printing job is not all completed after the optimization to prevent off-balance in stacking in step S2507 or the optimization to detect full load at an early stage in step S2508 (NO in step S2509), the process is returned to step S2505, and the relevant processes are repeated. When the printing job is all completed (YES in step S2508), in step S2510, the data on the print sheets that were handled this time is added to the recorded data of the print sheets that were handled in the past, and this series of processes is terminated.

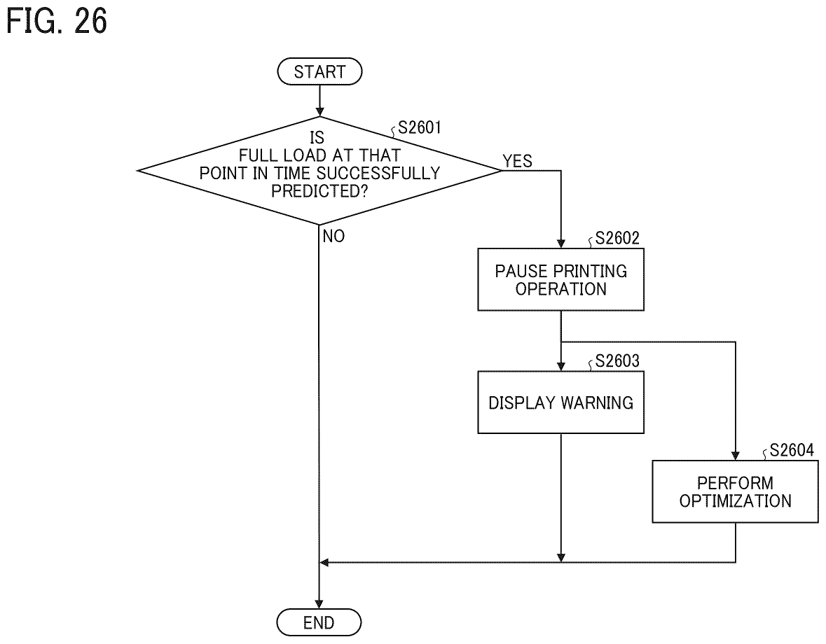

How to perform optimization to prevent off-balance in stacking is described below with reference to the flowchart of FIG. 26.

Firstly, whether how soon a tray will be fully loaded is predicted based on the sheets P that are ejected by the image-forming operation in step S2505 is determined. In other words, in step S2601, whether the output tray will be fully loaded soon is determined.

When the timing at which the output tray will be fully loaded is not predicted (NO in step S2601), the optimization to prevent off-balance in stacking is ended.

When the timing at which the output tray will be fully loaded is predicted (YES in step S2601), in step S2602, the printing operation is stopped on a temporary basis. In step S2603, the display unit 113 provides notification of off-balance in stacking. In step S2604, optimization is performed.

The optimization that is performed in step S2604 includes, for example, adjustment of sheet-ejection linear velocity, movement the output tray to a desired position, and adjustment of the sheet-to-sheet time interval, and the stackability on the output tray could be increased accordingly.

After the processes in step S2603 and step S2604, the optimization to prevent off-balance in stacking is ended.

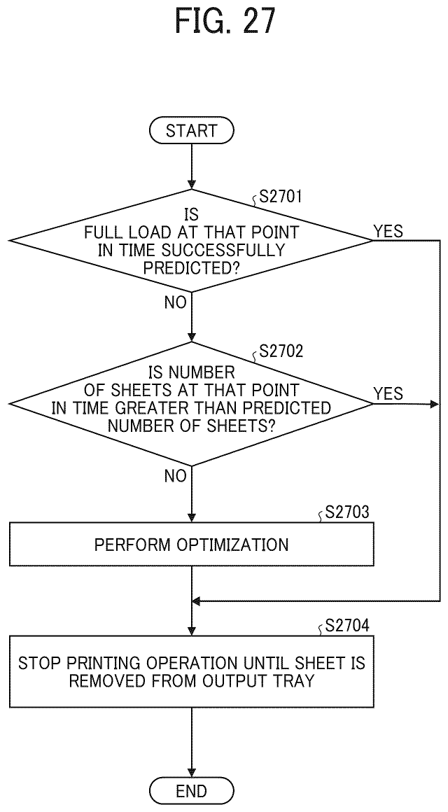

Processes executable without reaching a stacking limit are described with reference to the flowchart of FIG. 27.

Firstly, in step S2701, whether the learning model 500 has predicted that the folding-device output tray 325 will reach its capacity by the sheets P, which are ejected by the image-forming operation in step S2505, is determined. In actuality, instead of determining that a predicted value is equal to a counted number of sheets, a margin of 1 to 2% is set, and whether the predicted value is within the value range including the set margin is determined.

When it is not predicted that the folding-device output tray 325 will reach its capacity in the ejection of the sheets P this time (NO in step S2701), in step S2702, whether the current number of the sheets P stacked on the folding-device output tray 325 is larger than the number of the sheets P with which it is predicted that the tray will be fully loaded is determined. When the current number of the sheets P stacked on the folding-device output tray 325 is not greater than the number of the stacked sheets P with which it is predicted that the tray will be fully loaded (NO in step S2701), the medium sensor 303 is turned on despite the amount of stacked sheets that is smaller than the value predicted by the learning model 500. In such a case, it can be determined that the output tray has erroneously reached its capacity at an earlier stage.

When it is erroneously detected that a tray is fully loaded at an earlier stage, in step S2703, what is to be controlled in the image-forming processes is optimized, and the printing operation is optimized. How the printing operation is optimized has already been described as above.

When it is predicted that the folding-device output tray 325 will reach its capacity in the ejection of the sheets P this time (YES in step S2701), as the learning model 500 has predicted, in step S2704, the printing operation is ended until the sheet P is removed from the folding-device output tray 325.

When the current number of the sheets P stacked on the folding-device output tray 325 is greater than the number of the stacked sheets P with which it is predicted that the tray will be fully loaded (YES in step S2702), it is just as the learning model 500 has predicted, and in step S2704, the printing operation is ended until the sheet P is removed from the folding-device output tray 325.

### Fifth Example of User Interface

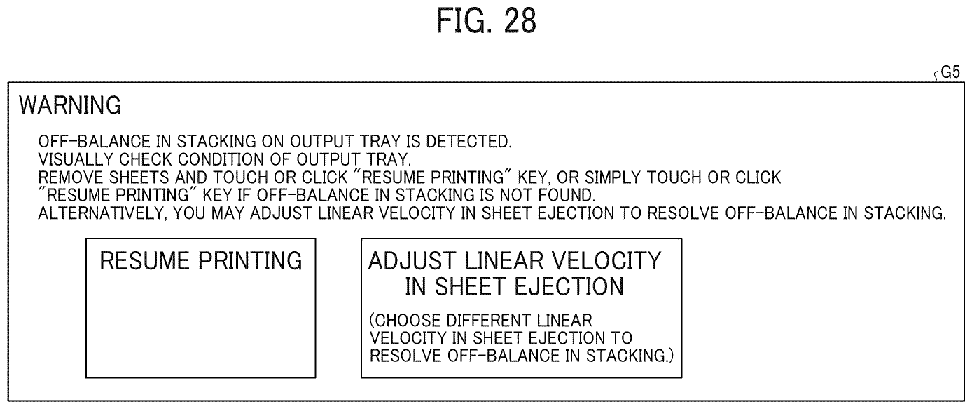

FIG. 28 is a diagram illustrating an attention calling screen G5 to display warning in step S2603.

The attention calling screen G5 is a user interface (UI) to indicate to a user ignorance and selection to resume printing, a possibility that the off-balance in stacking could be corrected by adjusting the linear velocity in sheet ejection, and a setting key or button to adjust linear velocity in sheet ejection.

### Fifth Embodiment of Control Processes

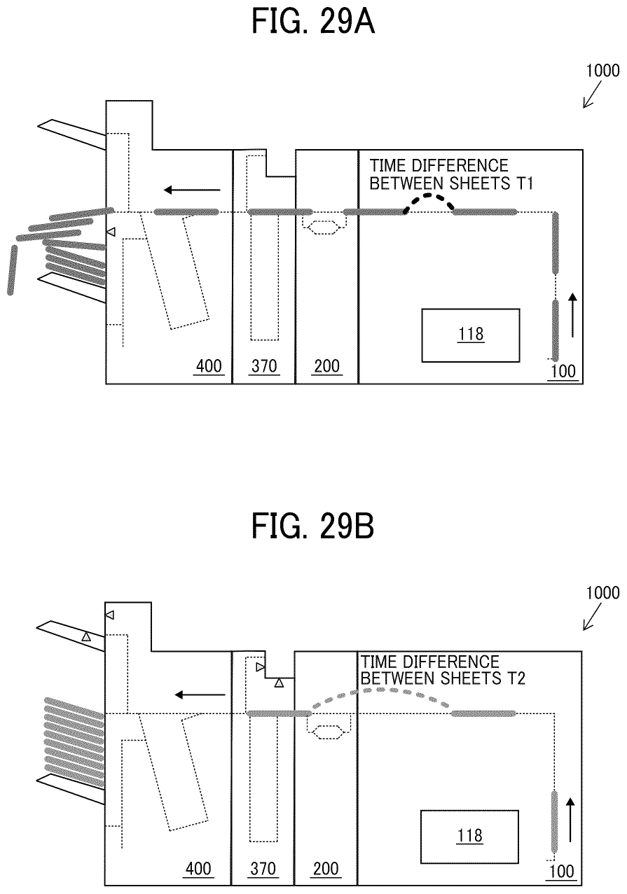

Control processes according to a fifth embodiment are described below with reference to FIG. 29A and FIG. 29B. In FIG. 29A and FIG. 29B, the intervals at which the sheets P are conveyed are controlled to increase the stackability.

When it is detected that the output tray has reached its capacity at an earlier stage or when it is determined in a timely manner that the fact that the output tray has reached its capacity is not yet detected, the stackability on an output tray could be increased by adjusting the intervals at which the sheets P are conveyed in the image forming apparatus 100.

As illustrated in FIG. 29A, for example, if a subsequent sheet P is ejected when some of the preceding sheets P that has just been ejected is not dropped to an output tray in a complete manner and is floating in the air, the preceding sheets P may be pushed off and off-balance in stacking may take place. The sheet-to-sheet time interval under such conditions is referred to as T1 in the following description.

As illustrated in FIG. 29B, the intervals at which the sheets P are conveyed in the image forming apparatus 100 are expanded. In other words, the sheet-to-sheet time interval is lengthened. By so doing, after preceding sheets P are stacked on the output tray and stored properly, the next sheet P is ejected. Due to such a control as described above, the stackability could be increased. The sheet-to-sheet time interval under such conditions is referred to as T2 in the following description.

In other words, when the optimization in step S2604 is performed while the sheets P are being conveyed at the sheet-to-sheet time interval T1 that is an example of a conveyance interval, the conveyance interval in the conveying operation is changed such that the sheets P will be conveyed at the sheet-to-sheet time interval T2 that is another example of a conveyance interval.

### Sheet-to-Sheet Time Interval T1<Sheet-to-Sheet Time Interval T2

Even if the sheet-to-sheet distance is simply changed, it does not make sense if the sheet conveyance speed is changed accordingly. In view of such circumstances, the sheet-to-sheet time interval is to be adjusted in an appropriate manner.

### Third Embodiment of Learning Model Generation

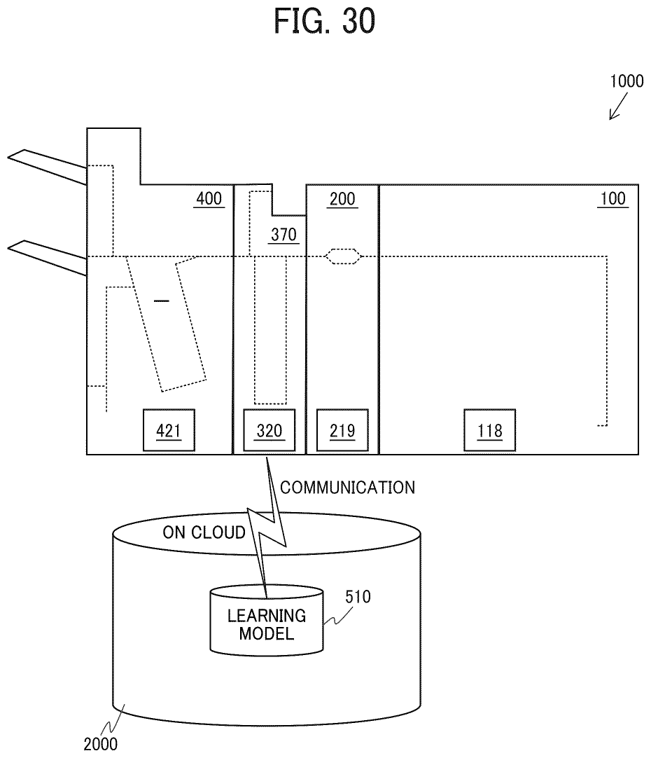

FIG. 30 is a diagram illustrating the external cloud system 2000 external to the image forming system 1000, storing the learning model 500 generated through the machine learning processes.

When a timing at which an output tray will be fully loaded is to be predicted in the image forming system 1000, the learning model 500 is stored on the cloud system 2000, and prediction can be made using the learning model 500 on the cloud system 2000 through the communication line.

Each of the apparatuses (such as the post-processing apparatus 400, the folding apparatus 300, and the decurler apparatus 200) other than the image forming apparatus 100 may be provided with a communication module, and may directly access and use the learning model 500 on the cloud system 2000 through the network. In such cases, the sheet information or the data about the post-processing operation is sent to the cloud system 2000, and the apparatuses (such as the post-processing apparatus 400, the folding apparatus 300, and the decurler apparatus 200) other than the image forming apparatus 100 receive the result of the estimation performed on the cloud system 2000 again. By so doing, the timing of a stacking limit or reaching capacity can be estimated.

The learning model 500 is stored on the cloud system 2000 under normal operating conditions, and the learning model 500 on the cloud system 2000 may be downloaded and used when the power of the image forming apparatus 100 or another processing device is turned on. In such a method or methodology, the communication between the image forming apparatus 100 or other post-processing apparatuses and the cloud system 2000 at the timing of printing is not necessary, and the length of time elapsed between the instant when a print job is given and the instant when the printing starts can be reduced.

As described above, according to the decurler apparatus 200, the folding apparatus 300, and the post-processing apparatus 400 each of which is an example of a medium processing apparatus, the timing at which the output tray provided for each apparatus reaches its capacity or stacking limit can be predicted when print settings are input by a user. As such a prediction is given to a user, the user can take out the media stacked on the output tray whose timing to reach the capacity is predicted before the output tray reaches its capacity.

As the media that are stacked on the output tray are taken out before the timing at which it is predicted that the output tray will reach its capacity, a decrease in productivity due to the termination of an image-forming operation or printing operation or a reduction in product quality due to the termination of processes during the job can be prevented. For example, the sheet bundle Pb can be prevented from being separated from each other. The possibility of errors in stacking or off-balance in stacking, which could take place as the media are stacked beyond the stacking limit of the output tray, can be reduced.

In the present embodiment, the learning model 500 that has done machine learning based on the data related to a series of jobs until the output tray reaches its capacity is used. Accordingly, the timing at which the output tray is expected to reach its capacity can be calculated according to the job when the image forming apparatus 100 is actually used.

When a sensor that detects that the output tray has reached its capacity is turned on at a timing earlier than the calculated time, it is assumed that the sheet P is inappropriately curled or the folding in the folding operation is insufficient, and what is to be controlled in the fold enhancement or decurling is optimized for the purposes of increasing the stackability.

According to one aspect of the present disclosure, a timing at which an output tray is fully loaded with stacked objects can be predicted when a job is set.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

### Aspects

Aspects of the present disclosure are, for example, as follows.

### First Aspect

A medium processing apparatus includes a medium stacker on which a medium is stacked, and a full-load prediction unit to predict a stacking limit on the medium stacker, based on attribute information of the medium and information about a process to be applied to the medium, and the full-load prediction unit predicts whether the medium stacker reaches the stacking limit when the medium is conveyed to the medium stacker before the process is applied.

### Second Aspect

In the medium processing apparatus according to the first aspect, the full-load prediction unit predicts a timing of the stacking limit when the process is applied to the medium.

### Third Aspect

In the medium processing apparatus according to the first aspect or the second aspect, the full-load prediction unit predicts the stacking limit based on a learning model generated by machine learning using training data in which the attribute information is associated with the information about the process to be applied to the medium.

### Fourth Aspect

In the medium processing apparatus according to any one of the first to third aspects, the medium stacker includes a full-load detection device to detect that the medium stacker is fully loaded with the medium. In the medium processing apparatus, a setting changer to change what is to be controlled in the process when a timing of the stacking limit predicted by the full-load prediction unit does not match a time at which the full-load detection device has detected that the medium stacker is fully loaded is further provided.

### Fifth Aspect

In the medium processing apparatus according to the fourth aspect, the process includes a curling correction for the medium.

### Sixth Aspect

In the medium processing apparatus according to the fourth aspect, the process is a number of times fold enhancement is performed for the medium.

### Seventh Aspect

In the medium processing apparatus according to the fourth aspect, the process is an ejection speed when the medium is ejected to the medium stacker.

### Eighth Aspect

In the medium processing apparatus according to the fourth aspect, the process is a conveyance interval when the medium is conveyed to the medium stacker.

### Ninth Aspect

In the medium processing apparatus according to the fourth aspect, the process includes a full-load detection in the full-load detection device. When the medium stacker is fully loaded with the medium, the process includes a control not to perform the full-load detection for the medium for which conveyance to the medium stacker is not to be stopped.

### Tenth Aspect

In the medium processing apparatus according to the fourth aspect, when the timing of the stacking limit predicted by the full-load prediction unit does not match the time at which the full-load detection device has detected that the medium stacker is fully loaded, what is to be controlled in the process is changed based on the process applied to the medium stacked on the medium stacker.

### Eleventh Aspect

In the medium processing apparatus according to the fourth aspect, what is to be controlled in the process is changed based on user selection data input through a user interface enabling a user to make selection.

### Twelfth Aspect

In the medium processing apparatus according to any one of the first to eleventh aspects, the medium stacker includes a load-amount detection device to detect a load amount of the medium and a position changer to change a position of a stacking tray depending on the load amount.

### Thirteenth Aspect

In the medium processing apparatus according to any one of the first to twelfth aspects, the full-load prediction unit predicts a time at which a load amount of the medium reaches a given ratio relative to the stacking limit.

### Fourteenth Aspect

In the medium processing apparatus according to any one of the first to twelfth aspects, the full-load prediction unit predicts a time at which a load amount of the medium reaches a given ratio relative to the stacking limit, and the medium stacker changes a position at which the medium is received in view of the load amount predicted by the full-load prediction unit.

### Fifteenth Aspect

In the medium processing apparatus according to any one of the first to fourteenth aspects, a notifying device to notify a user of the stacking limit is further provided. When the stacking limit is predicted by the full-load prediction unit at selection of the process, the notifying device warns the user about the stacking limit.

### Sixteenth Aspect

In the medium processing apparatus according to any one of the fourth to fifteenth aspects, a notifying device to notify a user of the stacking limit is further provided. When a time of the stacking limit predicted by the full-load prediction unit has come and the full-load detection device does not detect that the medium stacker is fully loaded, the notifying device notifies the user of one of off-balance in stacking on the medium stacker or an error of the full-load detection device.

### Seventeenth Aspect

In the medium processing apparatus according to any one of the first to sixteenth aspects, a memory to store a plurality of processes including the process in chronological order is further provided. When the stacking limit is predicted by the full-load prediction unit, at least one of the plurality of processes executable without reaching the stacking limit is performed on a priority basis.

### Eighteenth Aspect

In the medium processing apparatus according to any one of the first to seventeenth aspects, the full-load prediction unit obtains a timing of the stacking limit on the medium stacker predicted based on the attribute information of the medium and the information about the process to be applied to the medium, from an external device through a communication line.

### Nineteenth Aspect

An image forming system includes a medium processing apparatus including a medium stacker on which a medium is stacked and a full-load prediction unit to predict a stacking limit on the medium stacker based on attribute information of the medium and information about a process to be applied to the medium, and an image forming apparatus to form an image on the medium. Before the process is applied, the full-load prediction unit predicts whether the medium stacker reaches the stacking limit when the medium is conveyed to the medium stacker.

### Twentieth Aspect

A control program is executable by a medium processing apparatus having a medium stacker on which a medium is stacked, and the control program includes a full-load prediction step to predict a stacking limit on the medium stacker based on attribute information of the medium and information about a process to be applied to the medium. The full-load prediction step includes a step of predicting whether the medium stacker reaches the stacking limit when the medium is conveyed to the medium stacker before the process is applied.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disk (DVD), and/or the memory of an FPGA or ASIC.

What is claimed is:

1. A medium processing apparatus comprising:
a medium stacker on which a medium is stacked; and
processing circuitry configured to
predict a stacking limit on the medium stacker, based on attribute information of the medium and information about a process to be applied to the medium, and
predict whether the medium stacker reaches the stacking limit when the medium is conveyed to the medium stacker before the process is applied.

2. The medium processing apparatus according to claim 1,
wherein the processing circuitry predicts a timing of the stacking limit when the process is applied to the medium.

3. The medium processing apparatus according to claim 1,
wherein the processing circuitry predicts the stacking limit based on a learning model generated by machine learning using training data in which the attribute information is associated with the information about the process to be applied to the medium.

4. The medium processing apparatus according to claim 1,
wherein the medium stacker includes a full-load detection device to detect that the medium stacker is fully loaded with the medium,
wherein the processing circuitry changes what is to be controlled in the process when a timing of the stacking limit predicted by the processing circuitry does not match a time at which the full-load detection device has detected that the medium stacker is fully loaded.

5. The medium processing apparatus according to claim 4,
wherein the process includes a curling correction for the medium.

6. The medium processing apparatus according to claim 4,
wherein the process is to increase a number of times fold enhancement is performed for the medium.

7. The medium processing apparatus according to claim 4,
wherein the process is to adjust an ejection speed when the medium is ejected to the medium stacker.

8. The medium processing apparatus according to claim 4,
wherein the process is to adjust a conveyance interval when the medium is conveyed to the medium stacker.

9. The medium processing apparatus according to claim 4,
wherein the process is a full-load detection in the full-load detection device, and
wherein when the medium stacker is fully loaded with the medium, the process is a control not to perform the full-load detection for the medium for which conveyance to the medium stacker is not to be stopped.

10. The medium processing apparatus according to claim 4,
wherein when the timing of the stacking limit predicted by the processing circuitry does not match the time at which the full-load detection device has detected that the medium stacker is fully loaded, what is to be controlled in the process is changed based on the process applied to the medium stacked on the medium stacker.

11. The medium processing apparatus according to claim 4,
wherein what is to be controlled in the process is changed based on user selection data input through a user interface enabling a user to make selection.

12. The medium processing apparatus according to claim 1,
wherein the medium stacker includes:
a stacking tray;
a load-amount detection device to detect a load amount of the medium; and
a position changer to change a position of the stacking tray depending on the load amount.

13. The medium processing apparatus according to claim 1,
wherein the processing circuitry predicts a time at which a load amount of the medium reaches a given ratio relative to the stacking limit.

14. The medium processing apparatus according to claim 1,
wherein the processing circuitry predicts a time at which a load amount of the medium reaches a given ratio relative to the stacking limit, and
wherein the medium stacker changes a position at which the medium is received in view of the load amount predicted by the processing circuitry.

15. The medium processing apparatus according to claim 1, further comprising
a notifying device to give notification of the stacking limit,
wherein the notifying device gives a warning about the stacking limit when the stacking limit is predicted by the processing circuitry at selection of the process.

16. The medium processing apparatus according to claim 4, further comprising
a notifying device to notify a user of the stacking limit,
wherein when a time of the stacking limit predicted by the processing circuitry has come and the full-load detection device does not detect that the medium stacker is fully loaded, the notifying device provides notification of one of off-balance in stacking on the medium stacker or an error of the full-load detection device.

17. The medium processing apparatus according to claim 1, further comprising
a memory to store a plurality of processes including the process in chronological order,
wherein when the stacking limit is predicted by the processing circuitry, at least one of the plurality of processes executable without reaching the stacking limit is performed on a priority basis.

18. The medium processing apparatus according to claim 1,
wherein the processing circuitry obtains a timing of the stacking limit on the medium stacker predicted based on the attribute information of the medium and the information about the process to be applied to the medium, from an external device through a communication line.

19. An image forming system comprising:
a medium processing apparatus including
a medium stacker on which a medium is stacked and
processing circuitry configured to predict a stacking limit on the medium stacker based on attribute information of the medium and information about a process to be applied to the medium; and
an image forming apparatus to form an image on the medium,
wherein the processing circuitry predicts whether the medium stacker reaches the stacking limit when the medium is conveyed to the medium stacker before the process is applied.

20. A non-transitory recording medium storing a plurality of instructions which, when executed by one or more processors, causes the one or more processors to perform a method, comprising
predicting a stacking limit on a medium stacker based on attribute information of the medium and information about a process to be applied to the medium,
the predicting including predicting whether the medium stacker reaches the stacking limit when the medium is conveyed to the medium stacker before the process is applied.
